(19) United States
(12) Patent Application Publication
(10) Pub. No.: US 2004/0005258 A1
(43) Pub. Date: Jan. 8, 2004

(54) Chemical reactor templates: sacrificial layer fabrication and template use

(76) Inventors: Stephen J. Fonash, University Park, PA (US); Chih-Yi Peng, University Park, PA (US); Ayusmen Sen, University Park, PA (US); Seong H. Kim, University Park, PA (US); Henry C. Foley, University Park, PA (US); Bin Gu, University Park, PA (US); Wook Jun Nam, University Park, PA (US); Kyuhwan Chang, University Park, PA (US)

Correspondence Address: MORGAN LEWIS & BOCKIUS LLP, 1111 PENNSYLVANIA AVENUE NW, WASHINGTON, DC, 20004, US

(21) Appl. No.: 10/317,153

(22) Filed: Dec. 12, 2002

Related U.S. Application Data
(60) Provisional application No. 60/339,689, filed on Dec. 12, 2001.
(60) Provisional application No. 60/352,432, filed on Jan. 23, 2002.
(60) Provisional application No. 60/431,204, filed on Dec. 6, 2002.

(51) Int. Cl. B01J 8/00; B29C 47/78; D06M 10/00; B05D 5/12

(52) U.S. Cl. 422/271; 422/222; 422/190; 264/211.24; 264/464; 427/402; 427/58

(57) ABSTRACT

The invention relates to chemical reactor templates having channel-like voids parallel to the template's major axis. The channel-like voids may have either micro-scale or nano-scale cross sectional areas. The chemical reactor templates may be used to produce micro- and nano-scale filaments and particles which have a variety of uses. In some embodiments a chemical reactor template of the invention have at least two intersecting channel-like voids substantially parallel to the major axis of said template. The invention also relates to methods for manufacturing a chemical reactor template using sacrificial layers. The chemical reactor templates of the invention may be fabricated to have multiple arrays of channel-like structures as well as vertical elements to provide access to act as contacts for the channel-like voids and materials formed within the template. The invention relates to methods for producing filaments and particles using a chemical reactor template. The filaments or particles are formed within the channel-like void to produce a filament within the channel-like void and may be extruded from the chemical reactor template. Using the chemical reactor templates one can fabricate a wide variety of devices having at least one contact region between a first and second material system over a substrate. Another aspect of the invention is the filaments made using a chemical reactor template of the invention. Accordingly the invention relates to an oriented filament has a nano- or micro-scale cross-sectional area and is prepared within a channel having a nano- or micro-scale cross-section.

### PRIORITY CLAIM

This application claims benefit under 35 U.S.C. §119(e) to Provisional Application No. 60/339,689, filed Dec. 12, 2001; Provisional Application No. 60/352,432, filed Jan. 23, 2002; and Provisional Application No. 60/431,204, filed Dec. 6, 2002.

### GOVERNMENT RIGHTS

The United States Government has rights in this invention under Grant No. NSF NIRT DMI-0210229, granted by the National Science Foundation.

### FIELD OF THE INVENTION

The invention relates to chemical reactor templates having channel-like voids parallel to the template's major axis. The channel-like voids may have either micro-scale or nano-scale cross sectional areas. The chemical reactor templates may be used to produce micro- and nano-scale filaments and particles which have a variety of uses.

### BACKGROUND OF THE INVENTION

Particles and filaments with micro- or nano-scale cross-sections have a number of potential technological applications. Many of these arise from the novel fundamental chemical and physical properties which they can display due to their nano-sized dimensions. See, e.g., “Nanoscale Electronics”, Chemical & Engineering News, Sep. 30, 2002, p. 38. The novel and fundamental chemical and physical properties are seen, for example, in the magnetic properties of nano-filaments (such as Mn 12) which can be much different from those of the bulk. The same is true for properties such as mechanical, ferroelectric, sensing, and electrical conductivity behavior of filaments. For example, the intrinsic room temperature conductivity of polyacetylene filaments is estimated theoretically to be greater than copper. This property has not been achieved yet in the bulk due to the high defect concentration found in polyacetylene bulk materials (S. Kilverson, A. J. Heeger, “Intrinsic Conductivity of Conducting Polymers” Synth. Met. 22, 371, 1988; L. Pietronero, “Ideal Conductivity of Carbon π Polymers and Intercalation Compounds” Synth. Met. 8, 225, 1983) but can be attainable in filaments which can vary from being formed from a relatively small number of oriented molecules down to even just one molecule. Conducting nanowires or filaments, such as polyacetylene, semiconductor nanowires, or carbon nano tubes (CNTs), are examples of nano-filament structures which can play a critical role in the advancement of electronics and opto-electronics. They offer intriguing possibilities for the fabrication of micron and nanometer scale molecular-electronics or nano-electronics devices as well as interconnects integrating these devices together. The filaments of this invention can be used as p-n junction diodes or field effect transistors (FETs) by creating oriented nanowires with proper doping arrangements. Arrays of such filaments can also be used to create high density, three-dimensional circuits and arrays.

Despite those important potential applications and recent progress in conducting nanowires synthesis, progress with nanowire applications has been slowed due to problems with post-synthesis handling. Most approaches using nano-filaments such as nano-wires require the handling of individual nano-filaments to attain positioning and orienting. This required manipulation is not conducive to an economic, high through-put, manufacturable technology. For example, approaches to producing filaments exploiting magnetic properties generally do not directly result in oriented filaments; orienting a number of filaments requires additional steps. The same is true for conducting filaments. The demonstration of this can be found by noting that many syntheses approaches to producing conducting polymer nanowires use membrane templates to define the nanowire diameter, and the resulting nanowires are collected by dissolving the template in an appropriate solution (Charles R. Martin, “Membrane-Based Synthesis of Nanomaterials”, Chem. Mater. 8(8), 1996). In such situations, it is difficult to orient a nanowire and place it at a specific location to assemble an electronic, magnetic, sensing, etc. device. Assembly techniques such as those based on electric field or self-assembling molecule approaches have been tried. CNTs are examples of filaments that generally also have this problem. Often they are produced by chemical vapor deposition, laser ablation, microwave, and carbon arc techniques resulting in the need for additional efforts to position the CNTs (Iver Schmidt, “Carbon Nanotube Templated Growth of Mesoporous Zeolite Single Crystals”, Chem. Mater. 13(12), 2001; Y. C. Sui, “Structure, Thermal Stability, and Deformation of Multi-branched Carbon Nanotubes Synthesized by CVD in Anodic Aluminum Oxide Template”, J. Phys. Chem. B. 105(8), 2001; Takashi Kyotani, “Preparation of Ultra-fine Carbon Tubes in Nanochannels of an Anodic Aluminum Oxide Film”, Chem. Mater, 8(8), 1996).

Recognizing that progress with micro- and nano-scale applications has been slowed due to problems with post-synthesis handling, this invention answers that need by providing chemical reactor templates having channel-like structures with micro- and nanoscale cross sectional dimension. The invention relates to the fabrication and use of such chemical reactor templates to produce micro- and nano-scale filaments and particles.

### BRIEF DESCRIPTION OF THE FIGURES

FIG. 1 depicts exemplary schematics of chemical reactor templates in material filament production. As shown the filaments are continuously removed and used ex situ.

FIG. 2 depicts an exemplary schematic of a chemical reactor templates in material filament production. As shown the filaments are used in situ. In this particular case, the chemical reactor templates are arranged to give an array of devices, such as chemically sensitive filaments, with built-in electrical contacting.

FIG. 3 depicts a general scheme showing the use of void-rich or void-free sacrificial layers in the fabrication of chemical reaction templates according to the invention.

FIG. 4 depicts high surface to volume column-void network silicon.

FIG. 5 depicts positioned beads used as a high surface to volume sacrificial material.

FIG. 6 is an FESEM picture of an actual nano-channel template fabricated using a void-free sacrificial layer. The FESEM picture shows five 20 nm wide, 20 nm high nano-filament templates, which are spaced 200 nm apart.

FIG. 7 is an FESEM picture of two sets of templates each with 5 formed filaments. All these filaments are 20 nm high. Filaments in the left set all have a 170 nm width and filaments in the right set have a 120 nm width. All filaments are spaced 200 nm apart. Each set is separated by 10 μm.

FIG. 8 depicts a general scheme showing the use of SAM's as the void-free sacrificial layers in the fabrication of chemical reaction templates according to the invention. The figure shows how a self assembled molecular monolayer (SAM) can be used to form a channel structure. The molecules coat the surface, a film is deposited on the molecules and then the SAM's are removed.

FIG. 9 is an example of a general process fabricating and using a chemical reactor template of the invention achieve precise control of polymer nanowire formation.

FIGS. 10(a)-(c) are examples of fabricating and using a chemical reaction template in the specific case of catalyst region formation. Here Ti has been positioned in certain specified areas with respect to the sacrificial metal line using deposition (a) before or (b) after lift-off or (c) before sacrificial metal deposition followed by wet etching to pattern. The Ti is converted to TiClx by chemical reaction after templates are formed, then activated to be the catalyst via reaction with Al(C₂H₅)₃ gas followed by polymerization in acetylene gas.

FIG. 11 depicts a chemical reactor template and the use of growth guiding structures inside the template.

FIG. 12 depicts a chemical reactor template schematic for the production of oriented polyacetylene wires.

FIG. 13 depicts a chemical reactor template schematic for the synthesis of hollow carbon tubes from a nano-channel chemical reactor template

FIG. 14 depicts chemical reactor template schematics showing the synthesis of aligned polymer fibers by radical cationic polymerization in nano-channels of a chemical reactor template.

FIG. 15 depicts the use of a chemical reactor template to functionalize silicon oxide channels and synthesis of concentric composite polymer bundles. FIG. 16 depicts a schematic representation of the electrochemical-assisted polymer extrusion in a chemical reactor template.

FIG. 17 depicts a conducting nanowire resistor made by in situ use of a chemical reactor template.

FIG. 18 depicts a conducting nanowire diode made by in situ use of a chemical reactor template.

FIGS. 19(a) and (b) depict semi-conducting nanowires for transistor applications with coplanar (a) one-side single and (b) two-side double parallel nanowire gate made by in situ use of a chemical reactor template.

FIG. 20 depicts a semi-conducting nanowire transistor with vertical gate made by in situ use of a chemical reactor template.

FIG. 21 depicts a semi-conducting nanowire transistor with underneath planar gate made ex situ use of a chemical reactor template.

FIG. 22 depicts a nanowire array interconnected in three-dimensions with conducting plugs formed during horizontal element growth made by in situ use of a chemical reactor template.

FIG. 23(a) depicts a double and FIG. 23(b) a surrounding gate Field Effect Transistor in three-dimensions made by in situ use of a chemical reactor template.

FIG. 24 shows the use of a nanochannel chemical reactor template of the invention in the integrated manufacture of a field-effect transistor.

### SUMMARY OF THE INVENTION

This invention relates to relates to the fabrication and use of chemical reactor templates having channel-like voids parallel or perpendicular to the template's major axis. The channel-like voids may have either micro-scale or nano-scale cross sectional areas. The templates are used for particle and/or filament formation where aspects such as orientation, size, composition are patterned or gauged from the template architecture. The filaments, which can be one molecule or a set of molecules, can be of any prescribed dimensions. Specifically, the filaments and the particles have micro- or nano-scale cross-sectional dimensions due to the use of a chemical reactor template according to the invention. These grown materials can be used in situ providing an organized, manufacturable array of filaments and nanoparticles or such filaments and particles can be released (e.g., extruded) for ex situ use. For magnetic, electronic, photonic, sensing, optical, or opto-electronic device applications, for example, filaments can be used in situ, in the nano channel templates in which they were created, and contacted in this oriented array for applications including electronic devices and circuits, sensor arrays, displays, and ferro-electric and magnetic storage applications. Such in situ use even offers the ability to construct manufacturable three-dimensional structures for applications such as memory arrays, sensor arrays or transistor arrays. In fact the nano-filaments in some regions can be functionalized to be the devices and in other regions to be the interconnects.

Simple and effective approaches to locating reaction control elements, catalysts or initiators needed for filament creation for in situ or ex situ applications are disclosed. In addition, for ex situ applications of these filaments, the templated or directed formation approach of the invention accommodates electric field driven, chemical reaction driven, pressure driven or electrochemical extrusion.

Unlike the membrane template approaches in wide-spread use, the chemical reactor template architecture of the invention exploits channel-like structures substantially parallel to the templates major axis or, in other words, deployed parallel to a substrate bearing the chemical reactor template. This is achieved using sacrificial layers. There also can be vertical templates, template components, and/or access vias which interconnect with the horizontal-to-the-substrate template elements. These vertical components are produced by, means known in the semiconductor art, such as, for example, selective deposition, self assembly, chemical or electro-chemical etching. The versatile chemical reactor template architecture allows for ease of chemical access to growth regions and 3-D lay-outs which can be particularly useful for in situ applications. In accordance with the invention, chemical reactor template arrays can also be arranged in layers effectively giving membranes of unlimited extent for both evolution of filaments for ex situ use and 3-D arrays for in situ use.

The invention relates to chemical reactor templates having channel-like voids parallel to the template's major axis. The channel-like voids may have either micro-scale or nano-scale cross sectional areas. The chemical reactor templates may be used to produce micro- and nano-scale filaments and particles which have a variety of uses. In some embodiments a chemical reactor template of the invention have at least two intersecting channel-like voids substantially parallel to the major axis of said template. These intersections may be a T-intersection, a Y-intersection, an X-intersection, or a +-intersection and may be two or more micro-scale voids, nano-scale voids, or combinations thereof. The intersections provide areas for reactions within the templates as well as mechanical features. For example, one intersecting channel may contain a removable member which form a check valve at the intersection. The removable member may also contain a catalyst material for a chemical reaction. A chemical reactor template of the invention may also contain beads within at least a portion of one channel. The beads may form a bead bed reactor or other structure within the channel.

The invention also relates to methods for manufacturing a chemical reactor template. One method of the invention applies a sacrificial layer in a predetermined pattern on a substrate; applies a capping layer such that the sacrificial layer is disposed between the capping layer and said substrate forming a chemical reactor template; and removes a sacrificial layer to a create a channel-like void within the chemical reactor substrate, the channel-like void being substantially parallel to the substrate. The sacrificial layer may be a void-rich material, a void-free material, a self-assembled molecule material, or beads. A method of the invention may also includes steps where a functional material (e.g. a catalyst, a catalyst precursor, or an electrical contact) is applied to one or more regions of the substrate or the template being fabricate. The sacrificial material underlies or overlies at least a portion of the functional material. The chemical reactor templates of the invention may be fabricated to have multiple arrays of channel-like structures as well as vertical elements to provide access to act as contacts for the channel-like voids and materials formed within the.

In another embodiment, the invention relates to a method for producing a filament using a chemical reactor template. This method comprises the steps of introducing at least one monomer into a chemical reactor template having at least one channel-like void substantially parallel to the major axis of the template, and polymerizing said monomer within the channel-like void to produce a filament within the channel-like void. Any type of polymerization may be carried out in a chemical reactor template according to the invention. The filaments may be formed in and remain within the channel, in situ applications, or extruded from the chemical reactor template, ex situ use. The filaments may also be formed in situ and a portion of the chemical reactor removed to expose the filaments, another type of ex situ use. The chemical reactor templates of the invention may also be used to form particles. In this use, the monomers are polymerized to form particles within the template channels—both in situ and ex situ, as discussed. While this embodiment is discussed here in terms of polymerization, the chemical reactor templates, as discussed below, may be used for any type of chemical reaction and used to form filaments, particles, etc. of other materials. The advantage of the invention is the controllable and designable architecture of the chemical reactor templates.

The invention further relates to a method for producing at least one contact region between a first and second material system over a substrate. This method forms a first material system on a first region of the substrate, forms a second material system on a second region of the substrate, applies a sacrificial layer in a predetermined pattern on the substrate such that a portion of the sacrificial layer overlies at least a portion of the first material system and at least a portion of the second material system; applies a capping layer such that the sacrificial layer is disposed between the capping layer and said substrate forming a chemical reactor template; removes a sacrificial layer to a create a channel-like void within the chemical reactor template, the channel-like void being substantially parallel to the substrate; introduces at least one monomer into a chemical reactor template having at least one channel-like void substantially parallel to the major axis of the template and connecting the first and second material regions, and polymerizes the monomer within the channel-like void to produce a conductive or semi-conductive filament within the channel-like void and in contact with the first and second material regions.

In a preferred embodiment the monomer is acetylene and the filament is polyacetylene. In this method, as well as the filament preparations discussed above, the filament may be doped during or after the polymerizing step.

Another aspect of the invention is the filaments made using a chemical reactor template of the invention. Accordingly the invention relates to an oriented polymer filament having a nano- or micro-scale cross-sectional area prepared by polymerizing a monomer or comonomers with a channel having a nano-scale cross-section. In addition to the oriented polymer filaments the invention relates to other oriented filaments discussed below. for example, an oriented carbon nanotube filament having a nano-scale cross-sectional area prepared by polymerizing a monomer or comonomers with a channel having a nano-scale cross-section to form a polymer and decomposing the polymer within the channel to form a carbon nanotube filament.

### DETAILED DESCRIPTION OF THE INVENTION

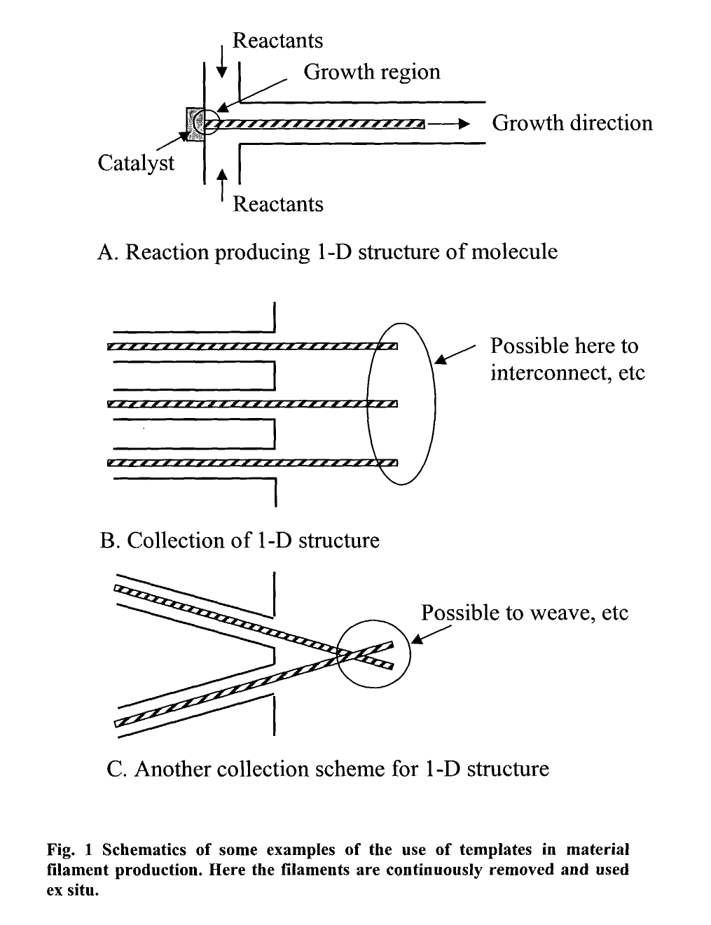

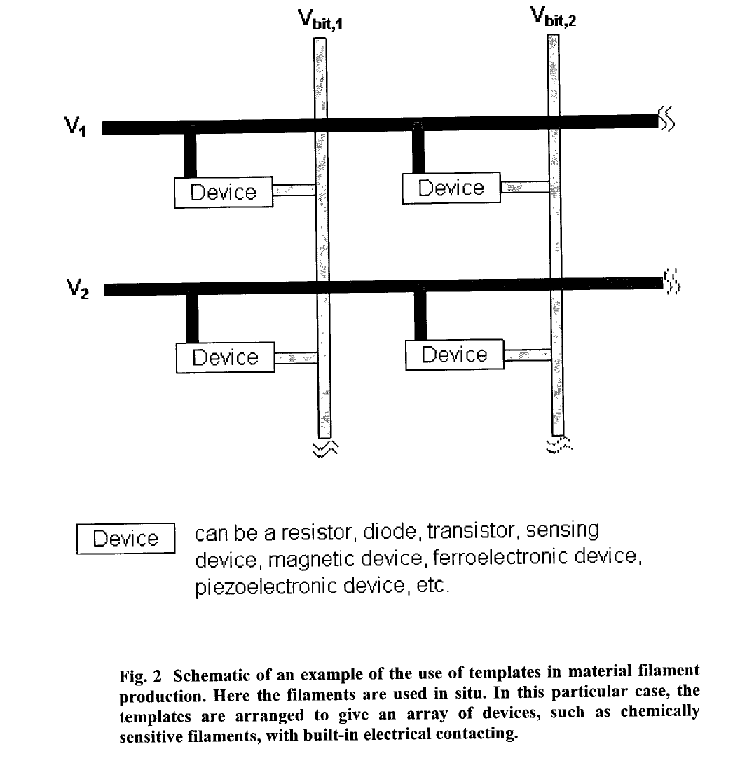

This invention has two components: (A) the use of sacrificial layers in the fabrication of chemical reactor template structures and (B) the application of template structures in filament production. The sacrificial layer materials are of three types and their use depends on the feature size involved: (A1) void-rich high surface to volume materials sacrificial layers for the fabrication of micro- and nano-scale template structures, (A2) void-free sacrificial layers for the fabrication of precise nano-scale features and (A3) self-assembled or directed assembly thin films. The use of chemical reactor template structures of the invention falls into two categories also: (B1) use of the templates to produce filaments that are removed from the templates (ex situ use) and (B2) use of the templates to produce filaments which remain in, and are used in, the templates (in situ use) or combinations there of. Some examples of the former ex situ use are seen in FIG. 1 and some examples of the latter in situ use are seen in FIG. 2. Architectures can exist in which the templated particles, filaments or products or both in situ and ex situ by being anchored in the template and extruded beyond the edges of the device.

The chemical reactor template architecture of the invention has the growth templates deployed parallel to the template's major axis, typically parallel to the substrate on which the template is formed. This is achieved using sacrificial layer approach. Sacrificial layers and their use with separation layers is described in published U.S. patent application U.S. 2002/0020053 A1 which is incorporated herein by reference. There also can be vertical templates, template components, and/or access vias which interconnect with the horizontal-to-the-substrate template elements. These vertical templates, template components, and/or access vias are connected to the horizontal elements by performing growth, deposition or etching steps known in the art.

Depending on the required feature size of the chemical reactor templates, of regions of these templates, or of access regions to these templates, the templates, as discussed in detail below, may be fabricated by using void-rich (high surface to volume ratio) sacrificial layers, by using void-free sacrificial layers, or by using some combination thereof. When completed, these templates may be used for producing material particles or filaments, which are then removed (ex situ particle or filament use), or for producing material particles or filaments, which remain, in situ, in the template sites and are used in place (in situ particle or filament use). The void-rich sacrificial layer is a substance with large pore or void content such as a bead-component material, an electrochemically etched porous film, a self assembled film, of a templated growth film, a deposited high porosity material, or some combination thereof. The important attribute of the void-rich sacrificial material is its high surface to volume ratio for ease of chemical and/or physical attack and removal. A particualry useful void-rich sacrificial material for the high-surface-to-volume-ratio sacrificial layer use of this invention is one where the voids are interconnected thereby enhancing transport of liquid, vapor, or gas species, through, and to, areas of the material. Void-rich material is more useful in creating relatively large volumes whose minimum feature size is at least 10 times larger than the characteristic void size dimension, but is not limited to these dimensions. The void-free sacrificial layer is a substance whose important attribute is that it has a highly specific, chemical removal agent. This allows for its efficient, precise removal without damaging other parts of the template structure. Generally, this type of sacrificial layer is useful for nano-scale featured templates or sections of chemical reactor templates. The particle, filament and product materials made by the template approach of this invention can have micro or nano-scale cross-sectional dimensions.

This invention addresses this need to position filaments produced in templates and does so without having to dissolve away the template structure. In the ex situ applications of filaments, using the template approach, the filaments can be extruded, pushed, or pulled from the templates and used elsewhere. If the fabricated filaments are not to be used in situ, then some extrusion process is needed. With the templates of the invention electric fields, chemical reactions and electro-chemical reactions may be used to effectively extrude filaments from the chemical reactor template. The driving force (physical or chemical) for extrusion must be strong enough to pull or push out the well-aligned nanowire from the channel for further applications, such as tape or wire formation. The chemical reactor templates of the invention are shown to be easily designed and fabricated to allow coating enhancements of the template's channels enhancing physical and chemical extrusion. One way to introduce a chemical reaction to propel a filament from the template is by introducing a nanoparticle coated with, for example, platinum and gold, and reacting it with, for example, hydrogen peroxide to produce water and oxygen, gases which push the filament from the template.

In magnetic, ferroelectric, sensor, electronic, photonic, mechanical, optical, and optoelectronic applications, one can envision situations where it is very beneficial to grow particles or filaments in the templates and to leave them there in place (in situ use). This approach avoids all issues of collection, orientation, and for electrical use, of contacting. Approaches to this in situ methodology are divulged here by examples which show schemes where this can be useful.

In all these situations, the chemical reactor templates function as growth templates for particles and filaments in this invention. As discussed below the invention provides fully designable and controllable templates in a manufacturable manner. These templates may be used to produce particles and continuous filaments for ex situ, or in situ filament use. In the case of the filaments, chemical reactor templates of the invention produce compositionally and morphologically defined filaments that are positioned and oriented, and of a length which is predetermined. These filaments can be used in situ (in the templates) offering manufacturable, precisely positioned 1-D, 2-D, or 3-D arrays of nano-filaments. In this case, these filaments, which may vary from single molecules to a set of molecules, can be easily accessed, sitting in the templates, because of their predetermined positioning, for in situ applications such as magnetic or ferroelectric information storage, sensing, electronics, optics, and opto-electronics applications. Alternatively these filaments can be extruded for use elsewhere. As discussed below filament produced in the chemical reactor templates of the invention using polymers but the applicability of this technique to CNTs and inorganic and organic particles and filaments of other materials is straightforward. Using the chemical reactor templates of the invention gives precise control over filament length, orientation, and location. A variety of organic and inorganic materials such as plastics, ceramics, glasses, insulators, metals, and semiconductors can be used as the substrates for the chemical reactor templates. The growth template structures can be deployed on or in such substrate materials. This flexibility arises from the process flow used which is designed to avoid the need for high temperature processing, if this is advantageous.

In general when initiators or catalysts are used in particle or filament chemical production or other materials formation steps, the chemical reactor template structure easily and simply accommodates any required local loading in the template channel. More specifically, the invention provides a simple and effective method to locally define, during template fabrication, any temperature control, catalytic, initiator, or other reaction control zones, if required. This same processing approach can be used to create electrical contacts for electric-field-driven, chemically driven or electro-chemical filament formation, extrusion, or both. Chemical reactor templates of the invention can also be used to create electrical contacts for in situ use of the filaments formed in the templates. In addition, the invention allows the use of self-assembly to further modify channel wall properties or dimensions during or after template completion.

Sacrificial-Layer Based Template Fabrication

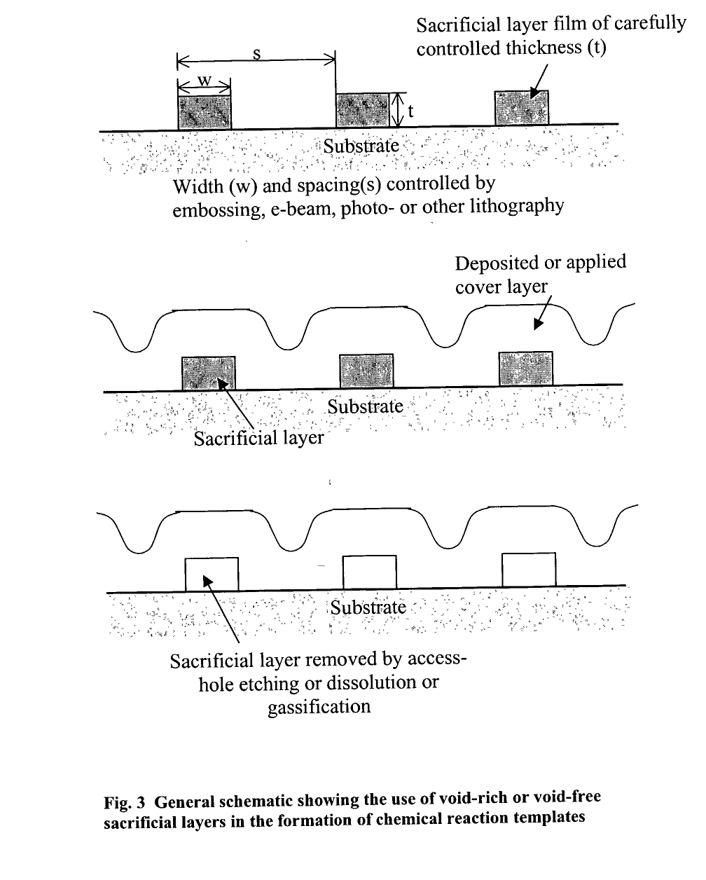

To fabricate chemical reactor templates of the invention and provide controlled, oriented production of micor- or nano-scale filaments sacrificial layers are used to create the empty template volume regions, as seen in FIG. 3. Template channel structures can be of the micron-scale in certain regions, as needed, but the actual template region for filament growth are preferably, but not necessarily, nano-scale regions. There is no limitation on the size of the template itself. Template formation may involve the use of void-rich, high surface to volume ratio sacrificial layers, void-free sacrificial layers, self-assembled or directed assembly thin films or both. Generally speaking, void-rich sacrificial layers are most useful in regions where large volume or cross-sectional channel-like voids are to be created in the template structure. Void-free sacrificial layers, self assembled or directed assembly are most useful in regions where precise, nano-scale features (channels or regions) are to be created in the template structure. Void-rich material is more useful in creating relatively large volumes whose minimum feature size is at least 10 times larger than the characteristic void size dimension.

FIG. 3 shows the general approach to creating channels or conduits with micro- or nanometer scale cross-sections. For the nano-scale cross-section template channels used in creating tailored, oriented molecules or structures (i.e., filaments) for exploiting the chemical and physical properties found in nano-scale cross-sectioned filaments, the dimensions w and t are in the nano-size regime. The dimensions w and t are in the micro-sized regime when micro-scale material growth regions are used. With the chemical reactor templates of the invention micro-scale channels or regions have, generally speaking, uses such as material introduction, formation of non-critical cross-section material, and filament merging applications.

The micro- or nano-scale cross-section channel formation seen in FIG. 3 is based on using e-beam lithography, ion beam lithography embossing (imprint) lithography, MIMIC, dip-pen nanolithography, photolithography, extreme UV lithography, flood exposure e-beam or ion beam lithography, laser ablation, screen printing, scribing, or other known approaches to defining the micro- or nano-scale dimension w using (mechanical writing, e-beam, photo, etc) resist layers. This lithography may or may not be used in conjunction with the molecular ruler approach using self-assembling molecules (SAMs) as the resist, as noted below, to give further flexibility in controlling and reducing the dimension w. SAM layers may also be used to tailor the interior dimension of the template region by building a layer or multiple layers of self-assembling molecules further constraining the w and h dimensions.

(A1) Use of Void-Rich Sacrificial Layers in Template Fabrication

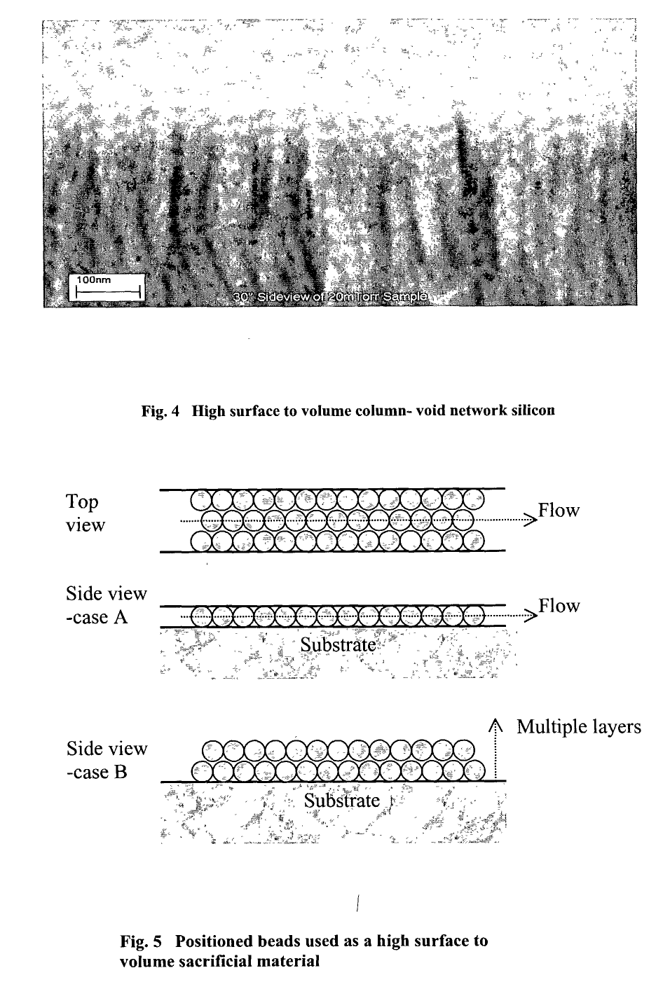

When void-rich sacrificial layer material is utilized to fabricate a chemical reactor template of the invention, such as in FIG. 3, the sacrificial medium is a high surface to volume material such as nano- or micro-scale beads or a porous material such as a high surface to volume column void network silicon as shown in FIG. 4. The materials used for the void rich sacrificial materials could be oxides, nitrides, metals, semiconductors, ceramics, glasses, polymers, plastics, organics or combinations thereof. Specifically materials such as silicon, silicon oxide, silicon nitride, germanium oxide, germanium, aluminum oxide, indium phosphide, gallium, gallium arsinide, gallium aluminum arsinide, alumina, iron, iron oxide, palladium, platinum, gold, silver, aluminum, nickel, titanium, iridium, chrome, polycarbonate, and polymerization initiators, or combinations thereof. These materials can be modified by silicidation, alloying, implantation, oxidation, nitridization, annealing, chemical reactions, silanization and thiolation. Whatever void-rich material is used, it is preferably deposited and excess material is removed using a technique such as lift-off or deposited and defined using a lithographic technique and then wet or dry etched or selectively removed. The dimension t is controllable by controlling the deposition rate and time. Once the layer defining w (e.g., the resist) is removed the resulting structure is that seen in the top of FIG. 3. One or more cover layers are coated as seen in the middle of FIG. 3. This coating may be by techniques such as spin-on, nebulization deposition, or physical or chemical vapor deposition, molecular beam epitaxy, casting, grown from a liquid phase precursor (polymer or plastic) or screen printing. After coating, the sacrificial layer is removed by etching or dissolution. The agents performing this function gain access to the sacrificial layer through access holes through the capping layer or through or in the substrate or substrate edges. If the sacrificial layer and processing temperatures are appropriately chosen, gasification of the sacrificial layer may also be undertaken, materials (e.g., polymeric material such as polycarbonate) which decompose to gases or which sublimate at low temperatures are good choices for the sacrificial materials and reactions for its removal. If the molecular ruler approach is used, the region w is defined by deposition techniques such as: spin-on, nebulization deposition, physical or chemical vapor deposition, molecular beam epitaxy, casting, grown from a liquid phase precursor (polymer or plastic) or screen printing onto a self assembling molecular (SAM) “resist” layer or multiple layers of SAMs. The SAM layer or layers and the excess deposited material above the SAM may then be removed in a “lift-off” procedure. The SAM layer location has been defined in that case by a technique such as embossing, contact printing or e-beam lithography and then adherence to the surface defined or adherence to an open region in a resist exposing a tethering surface. Typical SAM molecules used for molecular rulers surface coatings and sacrificial layers may be used. These include, for example, organothiols, carboxylic acids, lipids, phospholipids, ethoxy silanes, methoxy silanes and chlorosilanes. The terminal R groups of these molecules can be amines, aldehydes, imides, methyls, carboxyls, carbonyls, cyano groups or almost any other functional group which can be synthesized or found naturally occurring that contains carbon, nitrogen, oxygen or metals.

The high surface to volume sacrificial layer used in FIG. 3 in the void-rich approach can be beads which may be tethered or bound (e.g., by self-assembling molecules, SAM's, discussed above) for ease of bead positioning, as seen in FIG. 5. As shown in FIG. 5, the beads are spherical in shape but the beads may be of any shape. Possible bead shapes include, but are not limited to, spheres, triangles, pyramids, cones, rods, blocks, etc. The tethering or binding can be controlled by: adherence to a surface defined lithographically, by the developing of an open region in a resist exposing a tethering surface, by directing bead positions using electric fields, by dielectrophoresis, chemical reactions, electroosmotic force, electrophoretic force, hydrogen peroxide decomposition, by directed growth or bead formation in situ. Packing beads of different diameters or approaches such as applying the capping layer by spin-on or nebulation (where the impinging particles are droplets) can be used to insure a continuous and smooth capping layer over beads. After capping, the sacrificial layer is removed as described in the general context of FIG. 3. In the case of beads made up of material which decompose to gases or which sublimate at low temperature, gasification or sublimation of the sacrificial layer may also be undertaken. When beads are used, some or all of the beads may be left in the channel or template, in at least some regions, for catalytic, temperature control, contact, anchoring, or electrokinetic flow control regions to be used in filament formation. Beads within a channel of a chemical reactor template may also be used as a bead-bed reactor. In this approach the application of the capping layer would be done after the bead positioning but, in at least some regions the beads would not be removed. The beads may be made of catalyst or catalyst precursor material appropriate for a given chemical reaction. Alternatively, the beads may be made of a support material and, when in place, the catalyst or catalyst precursor introduced to the beads via a channel of the template, followed by activation, and use in a chemical reaction within the chemical reactor template.

The use of beads as the high surface to volume material and the positioning of these beads has been discussed by M. Seul, “Light-Controlled Electrokinetic Assembly of Particles near Surfaces,” International Patent Application, W097/40385 April, 1997, the disclosure of which is incorporated here by reference. However, the use has been for biochemical analysis and not catalysis functions. More importantly, the beads have not been positioned using binders as described in the context of this invention, but by using light. Moreover, the use of beads as sacrificial layers for template channel construction has not been disclosed, to our knowledge.

Beads of very carefully controlled size from the micron to the nanometer size range are available commercially. The beads come in a number of compositions from dielectrics to metals; e.g., from silicon dioxide to gold. Common bead compositions include semiconductors; such as: silicon, cadmium sulfide, terelium, geranium, selenium, indium, indium phosphide, gallium, gallium arsenide, dielectrics such as: iron oxide, silicon oxide, silicon nitride, zinc sulfide, or metals such as: gold, silver, platinum, palladium, iron, copper, nickel, chrome, iridium, etc. The list above is exemplary only and not inclusive and mixtures, alloys or combinations of all the above materials may be used. These beads may be coated prior to use with other dielectrics, semiconductors, metals, SAM layers, ionic species, polymers, organics, silanes, alkane thiols, catalytic materials etc. to even further vary the compositions available.

Positioning beads within the chemical reactor template employs attachment chemistry approaches to form bead-bed reactor structures, as seen in FIG. 5. The basic approach is to apply binder A to the beads (molecule A) and binder B (molecule B) to the surface region to be covered by these beads. Binder A is then designed to react with binder B thereby tethering the beads to the surface covered with binder B. Alternatively linker C (molecule C) can link binder A and B. These tethering and/or linking reactions are designed to form covalent, hydrogen, VanderWalls, biological recognition, steric or electrostatic bonds. When this bonding occurs, a monolayer of beads is strongly bonded on the prescribed surface. This surface can be in a pre-established region such as the “floor” of a pre-fabricated but uncovered channel in a substrate (FIG. 5 top). Such a channel would then be subsequently covered after the bead application using procedures such as spin-on glasses or other materials or physically or chemically vapor deposited materials. Alternatively the surface can be a region, which has the beads, applied first (FIG. 5 bottom) and is then encapsulated by deposition to create the closed region or channel. Whether the surface to which the beads are to be applied is the floor of a channel or not, that surface can be pretreated or coated prior to linker application to increase its linking abilities. For example, porous or roughened materials such as a column-void network silicon, polymers, nanostructured metals or porous oxides(FIG. 4) with its nanometer scale features can be applied to channel floors or other surfaces to increase surface binding capabilities. The surface could also be roughened by wet etching or dry etching or bombardment.

The bead layers in the chemical reactor template structures can be single layers or multiple layers as seen in FIG. 5. The latter case can be accomplished in a number of ways known in the art. For example, layering can be accomplished by applying a linker B or a new linker ‘B’ onto preceding, already positioned bead layers and then re-introducing beads with linker A. To control the reactivity of bead surfaces, un-reacted binder may be modified, washed, dissolved, or etched off during or after fabrication.

An alternative approach to position these micro or nano-scale beads when a bead-bed reactor is the objective is to create the micro-scale or nano-scale encapsulated channel structure first. After the channel is created the beads may be introduced by a fluid and at a flow rate that positions the beads in the channel. A surfactant, for example, may be included to help in this flow and positioning. Bead back filling in a channel could be initiated, for example, by beginning the filling process with larger diameter beads and positioning such beads using constrictions in the channels cross-section created during the channel fabrication. Another alternative approach to positioning beads is the formation of beads in situ using precursors and catalysts to drive nano or microparticle formation at different regions in the device. For instance silafins could be used to catalyze the formation silicon dioxide nanoparticles in solution or metals can be reduced inside of micelles, or reduced in the presence of surfactants or alkane thiols, to produce nanoscale particles. Beads may also be positioned or moved using electroosmotic force, electrophoretic force, chemical reactions, or dielectrophoresis.

If bead-bed inclusion in the template reactor channel is desired, the approaches described will lead to a bead distribution which is much more uniform than that found in conventional reactors. This result thereby mitigates against “hot spot” regions when the beads are functioning as a chemical bed reactor. The bead layers can also serve as heat conductors, certain layers can be heat conductors, or heat conductor beads may be positioned at certain locations in structures by varying the binders used to get selectivity and location in the template. The bead layer catalytic role may be tuned by positioning beads of predetermined composition or coating, or predetermined size at specific points along the flow or in specific layers, again by using series of binders that result in selective positioning.

As discussed, if the objective is not a bead bed reactor, these beads can be used as the high surface to volume sacrificial layer and removed creating an open template channel. In any of these situations, the width of the channel can be tens of nanometers to microns or larger and the length is as needed.

(A2) Use of Void-Free Sacrificial Layers in Template Fabrication

FIG. 3 also may be used to illustrate the basic process based on the use of void-free sacrificial layers. The use of a void-free sacrificial layer is advantageous when creating nano-scale, fine-featured template regions.

In preparing a chemical reactor template of the invention, any substrate could be utilized. In fact, the floor of the template may be the substrate. The floor of the template region may also be deposited by techniques such as spin-on, nebulization deposition, or physical or chemical vapor deposition, molecular beam epitaxy, casting, self assembly, grown from a liquid, vapor or gas phase precursor (polymers or plastics) or screen printing. The materials could be oxides, nitrides, metals, semiconductors, ceramics, glasses, polymers, organics. Specifically materials such as silicon, silicon oxide, silicon nitride, germanium oxide, germanium, aluminum oxide, indium phosphide, gallium, gallium arsinide, gallium aluminum arsinide, alumina, iron, iron oxide, palladium, platinum, gold, silver, aluminum, polymerization initiators. These materials can be modified by silicidation, alloying, implantation, oxidation, nitridization, annealing, chemical reactions, silanization and thiolation. A pattern is then created in a “resist” using embossing, probe, stamping, photo or e-beam lithography, ion beam lithography, MIMIC, dip-pen nanolithography, extreme UV lithography, flood exposure e-beam or ion beam lithography, laser ablation, screen printing, scribing or any other “soft” or “hard” lithography process that will chemically modify a controlled region of the resist. The void-free sacrificial material is deposited and lift-off is then used to define the sacrificial material that will be used to form the template region. The thickness of this sacrificial layer is to be carefully controlled since it defines the height of the template region. For nano-scale channels, it can be subnanometer or greater. The materials could be oxides, nitrides, metals, semiconductors, ceramics, glasses, polymers, organics or combinations thereof. Specifically materials such as silicon, silicon oxide, silicon nitride, germanium oxide, germanium, aluminum oxide, indium phosphide, gallium, gallium arsinide, gallium aluminum arsinide, alumina, iron, iron oxide, palladium, platinum, gold, silver, aluminum, nickel, titanium, iridium, chrome, and polymerization initiators. These materials can be modified by silicidation, alloying, implantation, oxidation, nitridization, annealing, chemical reactions, silanization and thiolation. Finally a capping layer is applied over prescribed regions as shown. The capping layer materials could be oxides, nitrides, metals, semiconductors, ceramics, glasses, polymers, organics. Specifically materials such as silicon, silicon oxide, silicon nitride, germanium oxide, germanium, aluminum oxide, alumina, iron, iron oxide, palladium, platinum, gold, silver, aluminum, polymerization initiators, or combinations thereof. These materials can be modified by silicidation, alloying, implantation, oxidation, nitridization, annealing, chemical reactions, silanization and thiolation. These materials can be deposited by techniques such as spin-on, nebulization deposition, or physical or chemical vapor deposition, molecular beam epitaxy, casting, self assembly, grown from a liquid, vapor or gas phase precursor (polymers or plastics) or screen printing. The floor material was thermally grown silicon dioxide, the resist was spun on and the template width w was defined by e-beam lithography, the sacrificial layer was physically deposited and its thickness t controlled by a deposition monitor, and the capping layer was deposited chemically (low pressure chemical vapor deposition). As discussed below, materials which can function as electrical contacts, initiators, growth components, or catalysts can be applied before the sacrificial layer introduction or after. If done after, these materials serving as electrical contacts, initiators, growth components, or catalysts can be applied and aerially defined before or after the capping layer. Applying such electrical contact, growth control, temperature control, or catalyst layers after the sacrificial layer, which will define the empty template channel volume, has the advantage of easily allowing for the avoidance of obstructions in what will become the empty template channel.

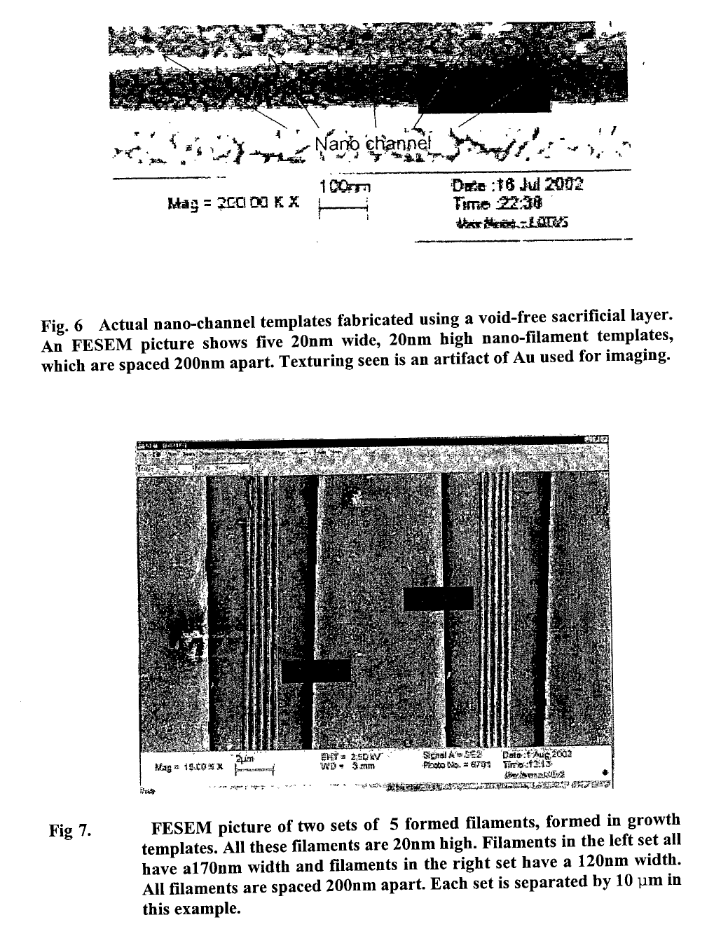

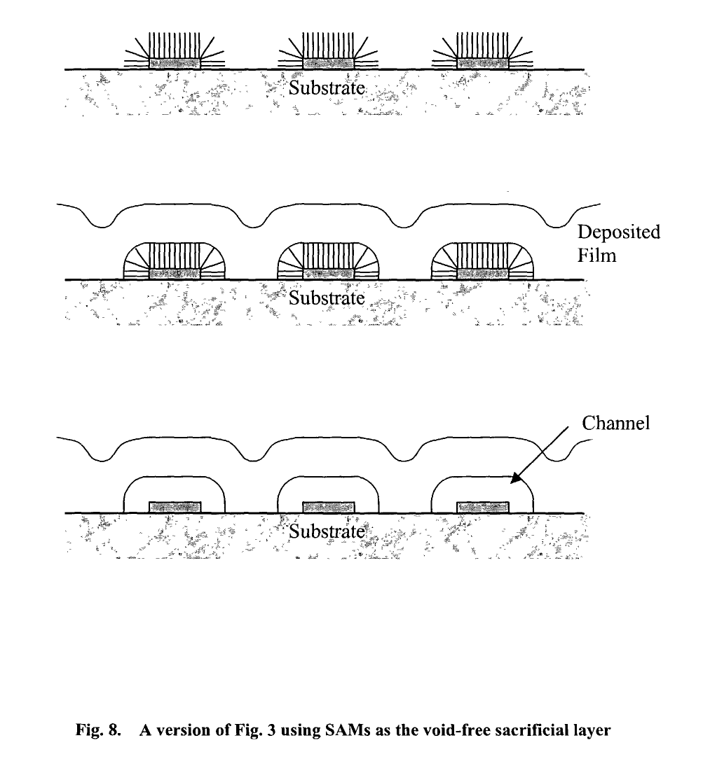

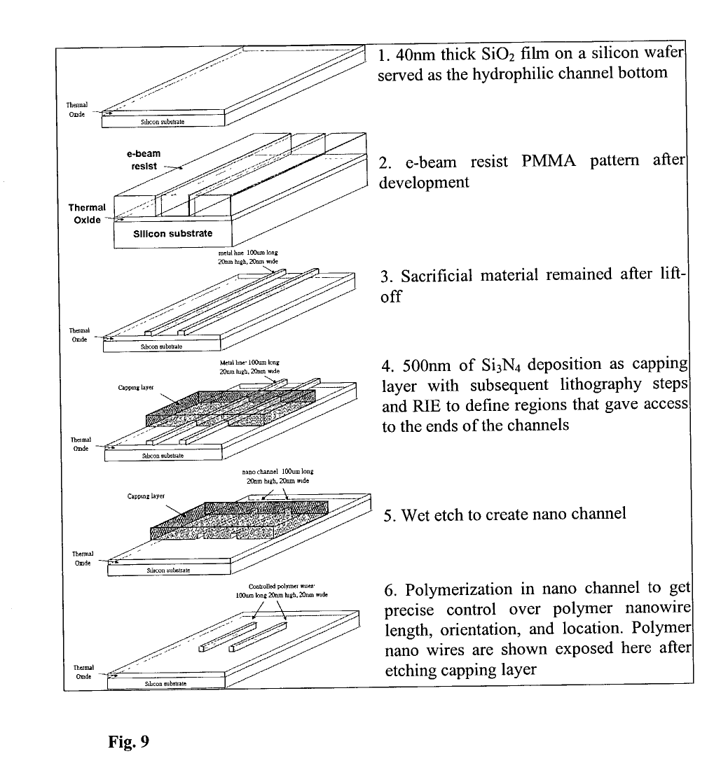

FIG. 6 shows 5 actual nano-channel templates fabricated as described above. These templates are empty; i.e., they have not been used as yet for filament growth. As may be noted, these empty templates have 20 nm by 20 nm cross-sections. The texturing is an artifact of Au used for imaging. FIG. 7 shows these channels are truly clear through their entire extent. This is established since the lines in FIG. 7 are polymer that has been grown in the templates. The capping layer (silicon nitride in this example) has been removed by etching in FIG. 7. Deposited nickel was used as the void-free sacrificial layer in this demonstration and it was removed by chemical etching. Since electrical contacts at the ends (or anywhere desired) can be present prior to sacrificial material removal, they can be used as electrical contact for electro-chemical etching and removal of the sacrificial material may be done, giving further process flexibility.

FIG. 8 shows an approach to producing a nano-scale void-free sacrificial layer created using assembling molecules (SAM). In this approach channel cross-section dimensions t and w are controlled by the number of molecule layers formed and the dimension of the attachment region. The SAM molecules are chosen to also assist in the cross-section control. The pre-defined attachment region is patterned by lithography approaches, including but not limited to embossing, e-beam, stamping, photolithography, MIMIC, ion beam lithography and molecular ruler techniques. The attachment region tethers the SAMs thereby determining the channel location and topology. When SAMs are used for the void-free sacrificial material, the deposition of the capping layer needs to accommodate the possibility that the SAM coverage is not 100%. Approaches such as applying the capping layer by spin-on or nebulation (where the impinging particles are droplets) can be used, if needed, to insure continuous and smooth capping layer internal surfaces, but, epitaxial growth, casting, screen printing, polymer growth or physical and chemical vapor deposition can still be used with the possibility of creating damage in the SAM layer. After capping, the void-free sacrificial layer is removed as described previously. Gasification of the sacrificial layer may also be undertaken.

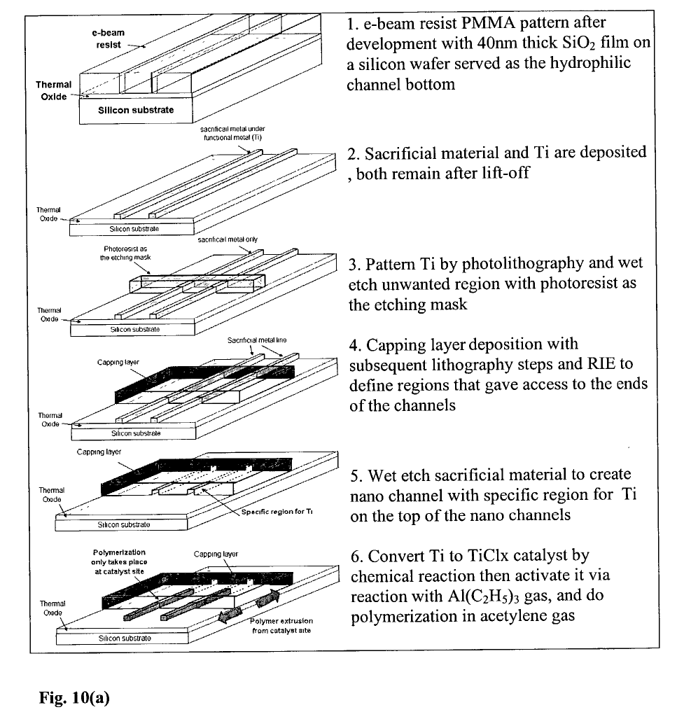

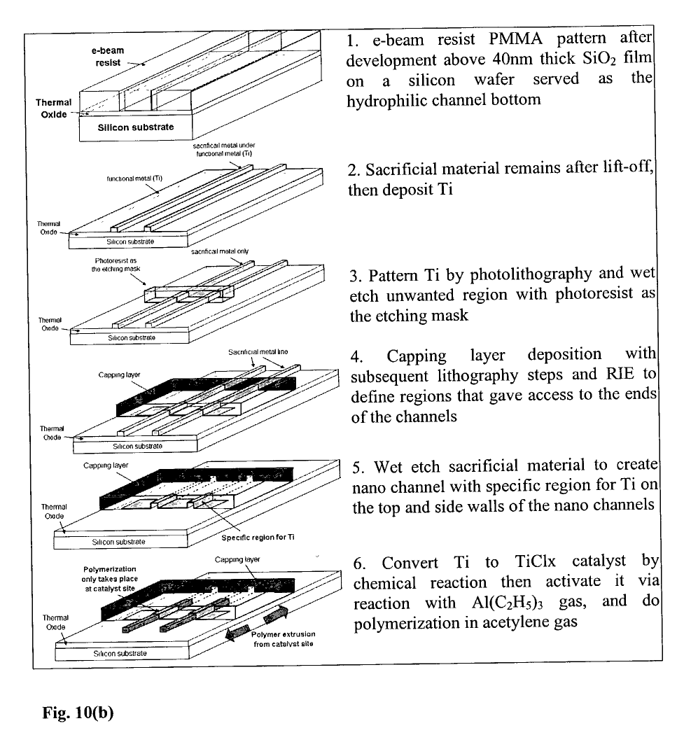

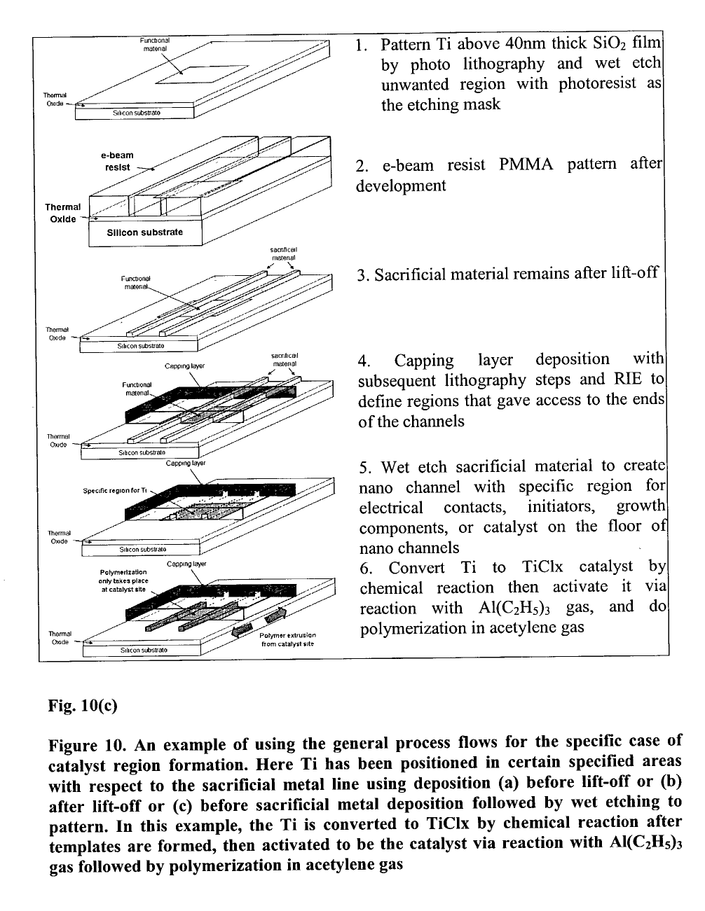

FIGS. 9-10 show, in general terms, the process flow modifications that can be made to create templates with electrical contacts, initiators, growth components, catalysts, light-impingement regions, temperature control regions, or some combination of these. As shown the additional layers used can be added before or after the void-free sacrificial layer. These regions that are to become electrical contacts, initiators, growth components, catalysts, etc. can also be aerially confined with an additional lithography and etching step, as required. Pattern definition may use known techniques such as embossing, soft lithography, e-beam, ion beam or photolithography and wet or dry etching, as needed. Actual materials used and material thickness may be varied.

FIG. 10 is a detailed specific example for general task of adding catalysts to the general process flow outlined in FIG. 9. For the example of FIG. 10a, the goal of the added regions is to load a polymerization catalyst locally inside the channel (template). By doing this, the polymerization will occur only at specific location inside the channel template. Taking acetylene as an example, a Ti-based Ziegler-type catalyst (Shirakawa catalyst) is employed in the process flow because this catalyst is most widely used for production of high-conductivity polyacetylene and it produces nanofibrils well suited to a nano-scale channel template. Three simple and effective approaches are shown in FIG. 10 as examples of locating this Ziegler-type catalyst in a certain area in the nano-channel. These are encompassed in the generalized approach of FIG. 9. One approach is that the Ti film is deposited with the sacrificial metal before lift-off, and Ti is patterned by lithography and etching after the lift-off as shown in FIG. 10(a). Another approach is that after lift-off of the void-free sacrificial layer, the Ti film is deposited and patterned as shown in FIG. 10(b). The other approach is that Ti film is deposited and patterned before the void-free sacrificial material deposition as shown in FIG. 10(c). After the deposition and the patterning of the capping layer and wet etching of the sacrificial material, the Ti film remains in certain area in the nano channels. Chlorine gas is then introduced into channel to react with Ti film and form the catalyst TiClx film. The surface-bound TiClx can be activated for polymerization via reaction with Al(C₂H₅)₃ gas. The activated nano channels will be placed in acetylene gas for polymerization. Since the catalyst is loaded only on the inside of the wall of nano channels, acetylene polymerization will occur only at specific location, but nowhere else. This simplifies the entire manufacturing process.

In all these approaches to chemical reactor template fabrication, additional materials for reaction initiation and control may be added by flow-through and inter template wall coating. By combining SAMs and tethering regions defined using the approaches of FIG. 9, one can position specific materials as predetermined any where within these growth template channels. Such materials can also be used to coat and therefore define channel dimensions in specific regions, single layers or multiple layers of SAMs may be deposited to make very thick three dimensional structures within the channels or template regions.

Templates in Molecule and Filament Production and Applications

However they are made, the use of these template structures disclosed here fall into three categories: (B1) use of the templates to produce filaments that are removed from the templates (ex situ use), (B2) use of the templates to produce filaments which remain in, and are used in, the templates (in situ use) and (B3) and templates to produce filaments which may be extruded from the templates but remain anchored to template for electrical, optical, physical contact or mechanical stability. Unlike the membrane template approaches in widespread use, the template architecture disclosed here is deployed parallel to its substrate, allowing ease of access and use, particularly for in situ applications such as, but not limited to, molecular electronics and sensing. With the approach disclosed here, template arrays can also be arranged in different layers of a given chemical reactor template, if needed, giving effectively membranes of unlimited extent. As noted earlier, there also can be vertical templates, template components, and/or access vias which interconnect with the horizontal-to-the-substrate template elements and are added with etching, selective deposition or self assembly.

(B1) Ex Situ Applications

FIG. 1 shows examples of several possible channel arrangements using nano-scale cross-section channels to foster the growth of one-dimensional molecules or structures. In FIG. 1a reactants enter as shown and impinge on a catalyst region driving the necessary reaction and the resulting fabricating molecule or structure migrates down the channel. The template channels, generally nano-channels, may be coated with catalysts that varied with position. Such coating could be done during channel fabrication or by flows done after fabrication. For example, carbon nanotubes, nanocrystals or nanoparticle, fullerenes, nanotubes, semiconductor nanotubes, metal nanotubes, dielectric nanotubes, nanoparticles, semiconductor nanoparticles, dielectric nanotubes or metal nanoparticles, or combinations or alloys thereof, could be produced in this manner yielding oriented, easily collected material. Common materials which nanotubes, nanocrystals or nanoparticles are composed of are but are not limited to; rare earth or alkaline metals, group IV compounds, 111-V compounds, II-VI compounds, silicon, silicon oxides, germanium, cadmium, cadmium sulfide, cadmium selenide, cadmium telenide, zinc sulfide, zinc, gallium, gallium arsenide, aluminum gallium arsenide, indium phosphide, iron, iron oxide, platinum, paladium, gold, silver, nickel, chrome, silicon nitride, or combinations or alloys of any of the above. Oxide materials may be used specifically for the catalysis of directional growth of carbon nanotubes with a second catalyst of gas phase ferrocene and xylene as a carbon source, in the manner described by Ramanath et al. “Organized Assembly of Carbon Nanotubes” B. Wei, R. Vajtai, Y. Jung, J. Ward, R. Zhang, G. Ramanath, and P. Ajayan, Nature 416, 495-496(2002). Possible collection schemes are also shown in FIG. 1. Since this use of a chemical reactor template according to the invention produces oriented materials, it is clear that this approach can be used to produce oriented properties such as oriented magnetic domains.

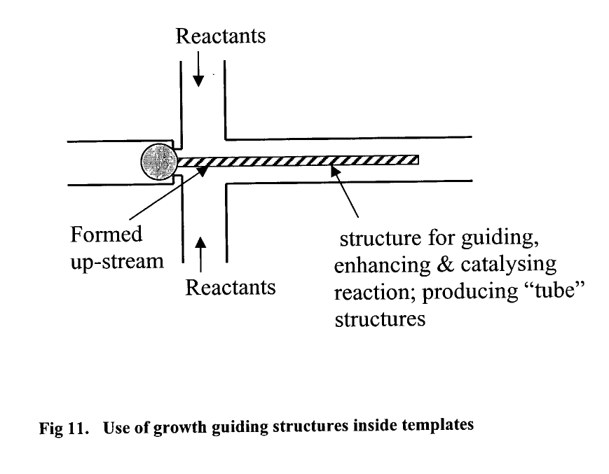

FIG. 11 shows a variation of FIG. 1 in which an oriented or particle structure such as a molecule is moved into position for reaction control using tethering to a bead. This structure is fabricated elsewhere and flow is used to move it into position. The approach of FIG. 11 can be used to create hollow tubes, particles or molecular structures. It allows repair and replacement or replacement of catalyst material. This also allows a chemical reactor template to be used for different reactions.

As an example of the utility of these approaches, and since the intrinsic room temperature conductivity of polyacetylene (PA) is estimated to be greater than that of copper, nano-wires of PA have the great potential of applications in nano-technology. However, the production of high-conductivity PA nano-wires has not been envisioned at all because there are no post-synthesis process suitable for fabrication of nano-wires from bulk PA materials. However, the nano-channels described above can utilize their geometric confinement effect during the polymerization process to orient macromolecules into nano-wires as they are synthesized.

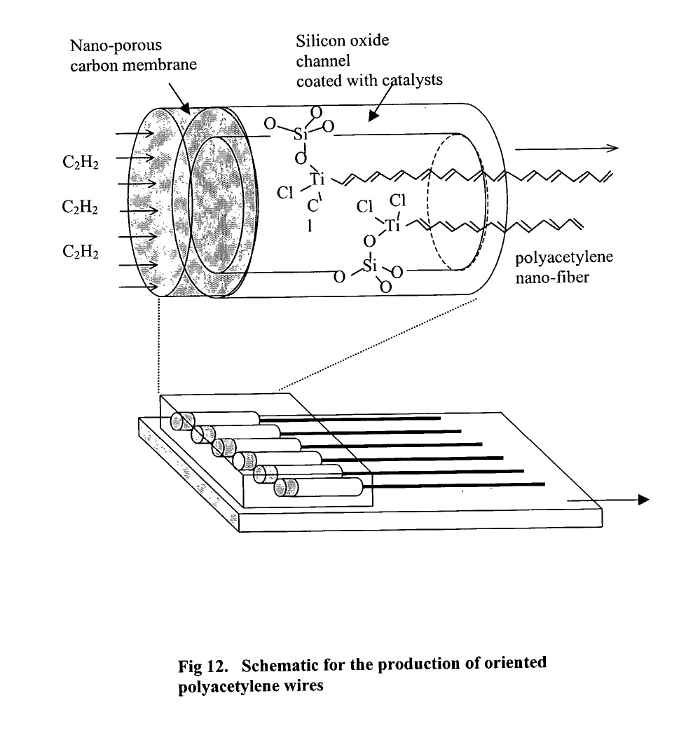

FIG. 12 illustrates an example of a synthetic route that could be used to highly-oriented PA nano-wires using nano-reactors containing polymerization catalysts tethered, linked or coated at the chemical reactor template walls. According to the invention nano-channel chemical reactor template are fabricated and aligned such that the PA wires are arranged into a desired geometry as they are extruded out of the template channels. The monomer inlet side is covered with nano-porous carbon membranes via pyrolysis of polyfurfyl alcohol at 600° C. This membrane allows monomer permeation, but not polymer chain penetration. (“Extrusion polymerization” in mesoporous silica has been recently reported.) Then the polymerization catalyst is loaded by hydroxylation of the nano-channel wall with O₂/H₂O followed by reaction with TiCl₄. The titanium chloride species anchored at the wall can be activated by reactions with Al(C₂H₅)₃. When C₂H₂ is introduced to this nano-channel reactor, polymerization will take place at the activated catalytic sites of the wall. The nascent polymer chains cannot fold within the narrow reaction channel and therefore grow out of the open end of the channel, resulting in the formation of well-aligned fibers. The diameter of the PA wire can be controlled by varying the nano-reactor diameter and the length of the wire can be controlled by varying the polymerization time or cutting the polymer at the end of the reactor channel.

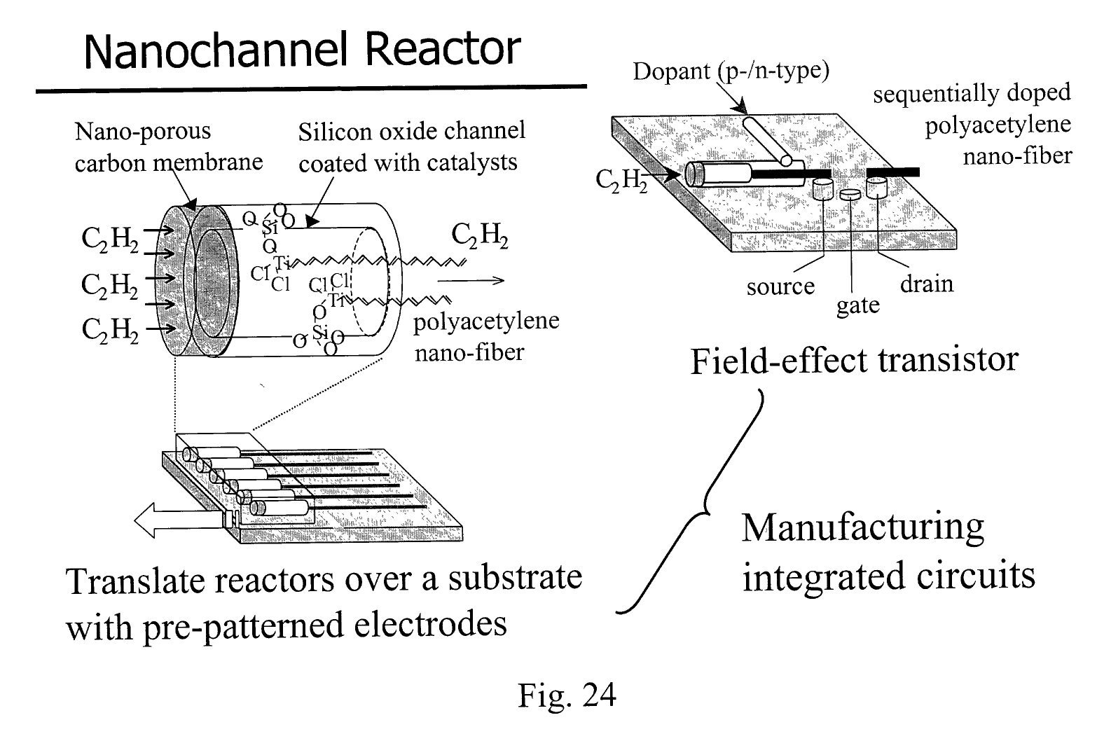

Because of the molecular control provided by the chemical reactor templates of the invention, particularly nano-channel chemical reactor templates, the PA nano-wires of this example can be doped as they are extruded from the nano-channel reactors. A dopant introduction channel can be fabricated to the downstream of the reactor channel. By sequentially introducing different dopants in the liquid, solid or gas phase, the invention allows the synthesis nano-wires regionally patterned with a dopant sequence and characterize their electrical properties to explore possible applications as nano-devices. For example, a p-n junction can be produced by introducing p-type dopant and n-type dopant sequentially, which can be used as an organic nano-rectifier. FIG. 24 shows the use of a nano-channel chemical reactor template of the invention in the integrated manufacture of a field-effect transistor. The polyacetylene filament is procured using a catalyst-functionalized channel within the reactor template. The polyacetylene filament is sequentially doped with p-/n-type dopants through a separate channel within the chemical reactor template. The template also contains source, gate, and drain regions to forming the field effect transistor.

By making a PA nano-wire with a doped-undoped-doped sequence and inserting it into a test channel patterned with metal electrode, we can investigate the field-effect transistor behavior of this device. Accordingly, use of a chemical reactor template of invention enables production a nano-circuit composed of organic nano-wires of electrical conductivity higher or of the similar magnitude of copper wires.

As another example, a chemical reactor template is used for the synthesis of hollow carbon tubes via photocatalytic polymerization of alkynes, using supported organo-transition metal carbenes as a catalyst/catalyst precursor, followed by on-chip pyrolysis (FIG. 13). In this example, these species are placed via chemical anchoring in a nano-channel covered with a layer of UV transparent material. A flow of alkyne gas or liquid with simultaneous UV irradiation leads to insertion and polymerization. The use of a chemical reactor template of the invention is novel and the product can be a highly oriented polyene fiber. The pressure gradient between the reactant inlet and the product outlet will push the polyene product through a nano-die or a nano-nozzle to produce “hollow” polyene nanofibers. Having formed the hollow fibers high temperature pyrolysis of the hollow fibers may be used to transform the fibers directly into carbon nanotubes. The primary product expected is multi-wall nano-tubes. With chemical reactor template design variations, such as constraining the template region by SAMs the polymer fibers can be one molecular layer thickness. Two-dimensional pyrolysis of this precursor can be done to form single-wall nano-tubes.

Aligned composite polymer fibers, tapes, and bundles are technologically important from several standpoints. First, aligned, well-ordered materials have, for example, electrical, magnetic or mechanical properties that are superior to the corresponding non-aligned materials. More importantly, synthesis of aligned composites of two or more polymers allow the construction of “smart” materials with multiple properties. For example, one of the polymers can act as a sensor (e.g., incorporate groups sensitive to specific chemicals)or adsorb specific chemicals changing the electrical, optical or magnetic properties. Also, the polymers can act as an electrical conductor (e.g., be conjugated), or be bioactive (e.g., incorporate groups that kill bacteria, interact with proteins and enzymes, interact with nucleic acids, interact with cells, interact with lipids, interact with cell surface receptors or nuclear receptors, or be ion sensitive), while the second imparts mechanical strength to the material. The component polymers may be incompatible with each other and yet it is possible to form multi-layered composites that are well-ordered down to nanometer scale using a chemical reactor template of he invention.

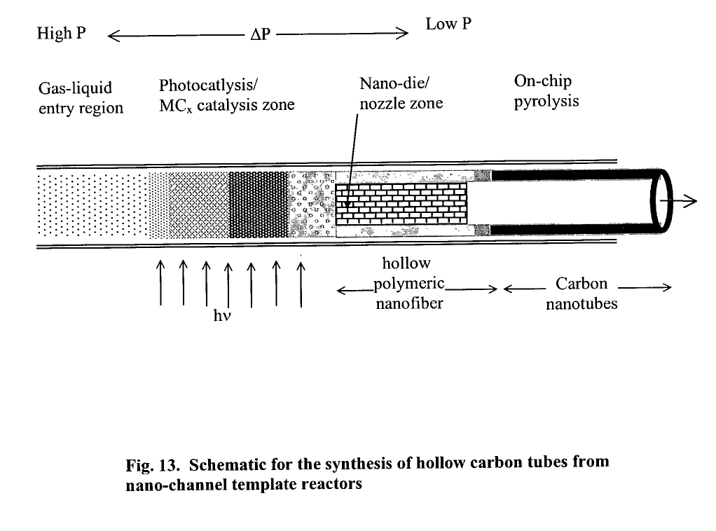

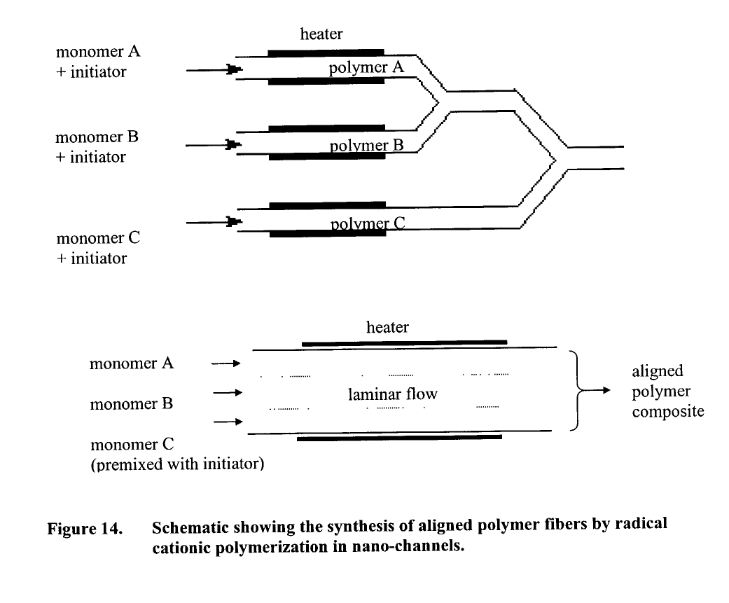

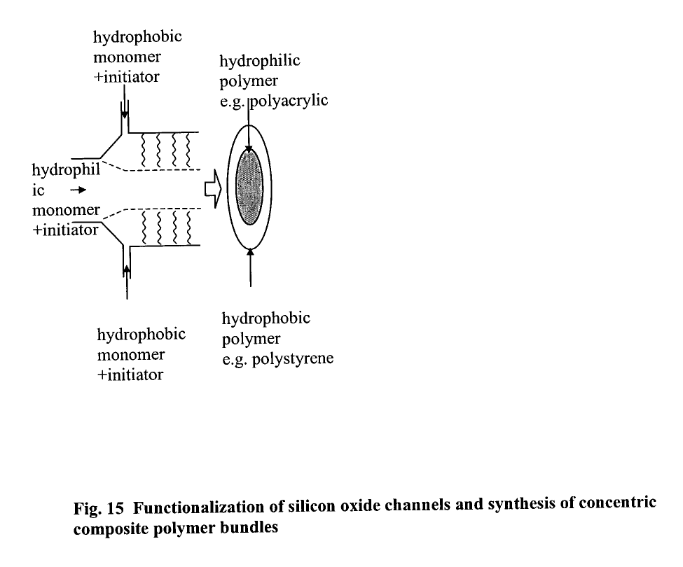

Other examples of preparative routes to composite polymer fibers, tapes, and bundles are summarized in FIGS. 14 and 15. Here polymer synthesis can be carried out in heated nano-channels that are approximately 20 nm in width and height. The width dimensions can be adjusted to form tapes instead of fibers. The monomers can be premixed with either radical or cationic initiators and fed into the nano-channel reactors. Initiators can be used to initiate polymerization only when heated, thereby preventing polymerization from occurring before the reaction mixture enters the reactor. An example of a suitable radical initiator is AIBN (2,2′-Azobisisobutyronitrile) which initiates polymerization around 80° C.

FIG. 14 illustrates two more exemplary approaches. In the first, the individual polymers can be synthesized in parallel nano-reactors and then brought together in a “nanospinaret.” In the second example, the synthesis of all the component polymers can be carried out in a single nano-channel reactor with a larger width. Laminar flow properties of liquids in nano-channels will be used to separate the individual reactant mixtures. A possible advantage of the second approach is that, because of entanglement of the two polymers at the flow boundaries, the adhesion between the individual component polymers increases.

The chemical reactor template architecture and its use allow for channel flow into channels and side channel flow into main channels. This gives the versatility of being able to add reactants, catalysts, and initiators at precise locations in reactions.

FIG. 15 illustrates another approach to synthesizing composite polymer bundles. The procedure is based on a recent report of surface-directed liquid flow in micro-channels and involves patterning hydrophobic, hydrophilic or charged regions in micro- and nano-channels. This shows the flexibility and adaptability of the chemical reactor templates of the invention. The region adjacent to the walls is made hydrophobic by using (long chain) alkyltrichlorosilane to form a self-assembled monolayer on the channel surfaces. Once patterned, the flow of a hydrophilic liquid will be confined to the center of the channel while a hydrophobic liquid will flow near the walls. The result is a concentric flow pattern and polymerization under these conditions will result in composite bundles where the hydrophilic polymer will be surrounded by the hydrophobic polymer. This concept can be extended to use general self assembled monolayers or other molecules that bind, adsorb, coat or adhere to a surface, which impart chemical, physical or electrical properties to the channel walls. Any patterns made with these molecules which define regions of hydrophobocity, hydrophilicity, or charge can modify the flow or interaction of the liquids in those regions. These patterns can change flow, separate flows, cause mixing or control reactions.

FIG. 15 depicts the use of a chemical reactor template to functionalize silicon dioxide channels and synthesis of concentric composite polymer bundles. The molecular coating may line the inside of the channel and act as a lubricant or a catalyst for filament production.

Since chemical reactor template fabrication allows the positioning of electrical contacts prior to filament growth, electric field and electrochemical growth processes may be utilized in filament production. For example, a conducting polymer can be synthesized by oxidative polymerization of the corresponding monomer. This may be accomplished electrochemically, with a chemical oxidizing agent with polymer growth templates, or by other known methods. An example of an electro-chemical approach is shown in FIG. 16. One end of the channel is coated with a porous material which functions as a membrane and as an electrode. This material separates the empty template region and the reservoir full of monomer. If the pore sizes of this porous electrode are properly chosen, this membrane will allow permeation of monomer into the channel, but not penetration of polymer chains out of the channel. This ensures the polymer extrusion through only the exit side of the channel. This porous electrode is the anode in this example and the conventional electrode (formed as in FIG. 9) associated with exit side of the channel is the cathode. This allows one to electrochemically synthesize the polymer at the catalytic zone within the nano channel templates. The electrochemical reaction can then assist the extrusion of the polymer effectively. The extruded conducting polymer nanowires are preferentially oriented parallel to the nano channel axial direction. This enhanced molecular order results in enhanced properties such as electronic conductivities due to fewer conjugation interrupting defect sites. In this example, the porous electrode can be created with a reaction localized in the template entrance at Reservoir A of FIG. 16. Alternatively, the non-porous electrodes of FIG. 9 can be fabricated at both ends of a template as outlined and electrochemical reactions can be driven using these.

(B1) In Situ Applications

In Situ Planar Configurations of Nano-Filaments for Nano-Magnetic, Photonic, Electronic and Sensing Devices and Device Arrays

For in situ application, chemical reactor templates having horizontally arrayed channels of nano-dimension cross-section have been fabricated, as shown in FIG. 6 and those nano channels have been used as templates for controlled filament growth. The dimensions of these nano templates have been fabricated to be t=20 nm high, w=20 nm wide, and 100 μm long as shown in FIG. 6. The width, height, and length are adjustable. These templates were used in the polymerization examples discussed above. After the polymerization in these nano channels, the polymer filaments are seen to remain, as shown in FIG. 7, after removing the capping layer (done for better imaging of the filaments), and the continuity of polymer filaments indicates the channels were open all the way without any collapsed regions before polymer formation. As outlined in FIG. 9 the processing flow that created such structures can be modified to add electrical contacts to the filaments for filament in situ applications; i.e., the filaments do not have to be removed from the channel templates but are utilized in place.

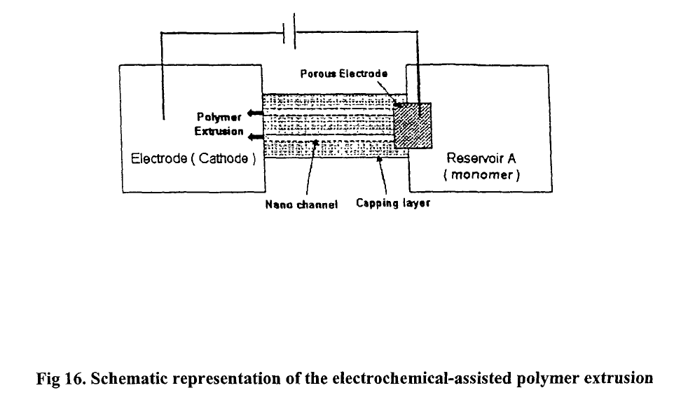

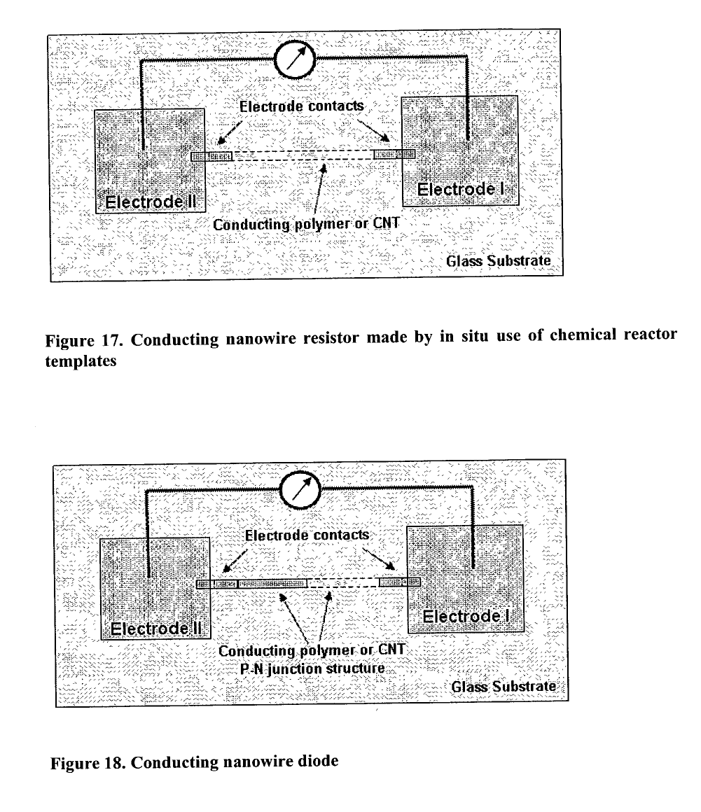

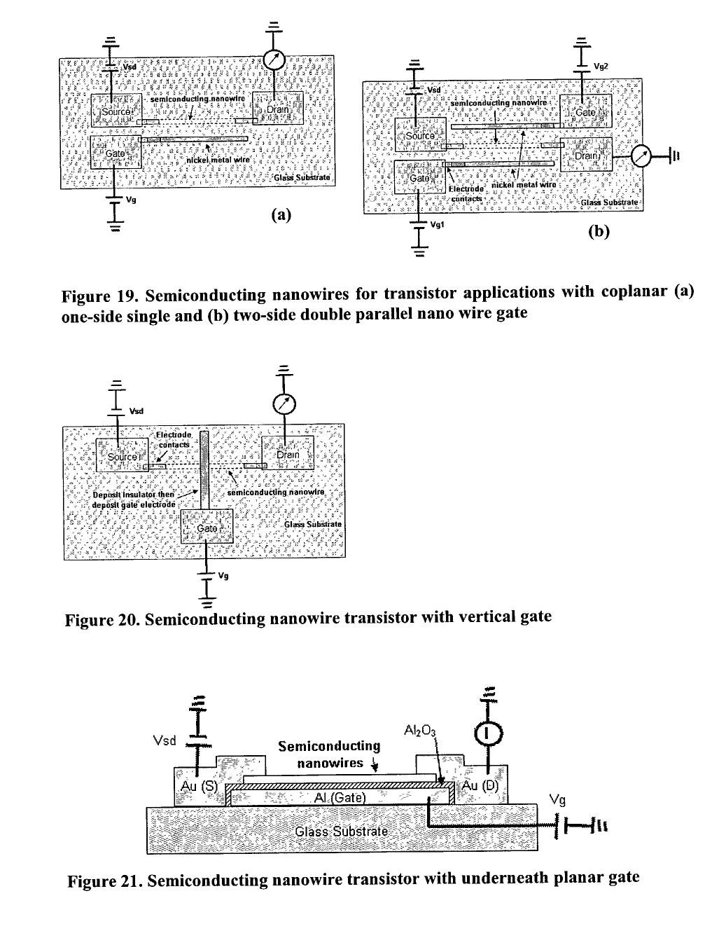

FIG. 17 is the schematic representation of using such a contacted conducting nanowire as a resistor. Of course, these conducting filaments can also be used as chip interconnects and such interconnects can be used for contacting the structures of FIGS. 19-23. The electrode contacts shown are formed as discussed in FIG. 9. They may be above or below the sacrificial layer during fabrication. When below, these can be deposited and patterned before lithography of the sacrificial void-free material for the nano channels. In general, the end contact (electrode I and electrode II) regions of FIG. 17 and other Figs do not have to be so large or even be present. They may be present to allow probes contact the outer for electrical measurements in development configurations. The electrode contacts can use a conducting material (such as a metal), semiconductor, doped semiconductor, silicide or materials system which is not etched away or removed by the etchant used to remove the sacrificial layer. Typical contact materials are metals such as: platinum, palladium, iridium, gold, silver, copper, aluminum or iron. Also semiconductors such as silicon, germanium, indium, indium phosphide, gallium, gallium arsinide or combinations or alloys of any of the above. Conducting polymers, such as polyacetylene, a metallic nanowire, a semiconductor nanowire or a carbon filament or nano tubes (CNTs), as examples, can be grown in the nano channel templates to serve as the conducting nanowires. These conducting nanowires are formed to the same size as the corresponding nano channel which means the nano channels are functioning as effective templates. The electronic and physical properties of conducting nanowires can be adjusted by the doping, if needed, and it may reach high conductivity with well-oriented nanowires due to fewer defect sites. Although not shown, many templates can originate at the same point or contact area. Therefore, a multitude of filaments can radiate out from one contact area and, if desired, complex “wiring” and connections can be formed.

These electrically contacted filaments or wires can also be doped for P-N or Schottky diode behavior. They can be doped so that specific regions are the P-N junction, and the remainder of the filament can serve as the interconnects. Such selective region doping may be done by means such as deposition into the template region prior to sacrificial layer creation or onto the sacrificial layer after its creation, ion implantation, plasma doping, diffusion or electrical drift. FIG. 18 gives a schematic representation of a P-N diode filament structure although Schottky diodes are also an obvious possibility. An alternating doping sequence along the conducting nanowires allows fabrication of P-N junctions. Taking a polyacetylene nanowire as an example for FIG. 18, the region with iodine doping can be p-type, and the region with alkali doping evaporated from a commercial getter source can be n-type. This schematic is not to scale. Much of the length of the filament can be interconnect and the actual electrode I and II pads may be non-existent since other filaments may join at the “ends” serving as interconnects and additional devices. These pads are shown here for ease of specific device measurement by probes in development work but need not be present in functioning product. Bi-polar transistor devices are also possible with this approach with suitable addition of a contact.

FIGS. 19-22 show three schematic views of FET fabrication. These are intended to demonstrate the wide variety of uses for the chemical reactor templates of the invention. There is no need for the filaments shown to be parallel; hence short channel structures can easily be fabricated by, for example, simply crossing filaments. In FIG. 19, the gate electrodes are un-removed sacrificial material such as nickel or another metal, semiconductor or doped semiconductor lying inside the nano channels which has been protected from etching by mask covering. These can be co-planar with template channels which have the sacrificial material removed. The gate can be single on one side as shown in FIG. 19(a), or double on two sides as shown in FIG. 19(b). The two-sided double gate scheme improves the on-off current controllability. The semi-conducting nanowire synthesized inside the template performs the FET channel role, and it is connected to a source and a drain at its two ends. Part or much of this filament may actually be circuit interconnect “wire.” While the channels and gates are co-planar in this example, this is not necessary. The current channel filament in these FETs can be undoped (i-type) with doped source, drain, and interconnect regions. Alternatively, the part of the filament which is the current channel can have an opposite doping to the source and drain regions. The gate insulator thickness is the spacing between channel and the gate and can be defined by lithography such as embossing or e-beam lithography. In FIG. 20, a layer of insulator is deposited followed by the strip of the gate electrode on top of it. And then the insulator is etched with the gate as the etching mask, and the whole device is exposed to dopant insertion by gas, liquid, plasma, bombardment, diffusion, or other doping approaches, which will lead to selective doping of the uncovered region. In FIG. 21, the gate electrode is fabricated underneath the insulating layer, for example, and an undoped nanowire, which will function as the current channel, is placed over the insulating layer. The insulating layer can be deposited or grown. In particular, in can be formed by self-oxidizing or anodization of the gate metal. The source and drain electrodes are deposited after the nanowire is formed in this Fig. Since the filaments can function as interconnects, a multitude of such filaments can fan out from what is labeled the “electrode contacts” in these Figs. meaning complex interconnecting configurations can be laid out and achieved by this filament in situ application of the chemical reactor templates of the invention.

(II) In Situ Three-Dimensional Interconnects and Devices and Device Arrays

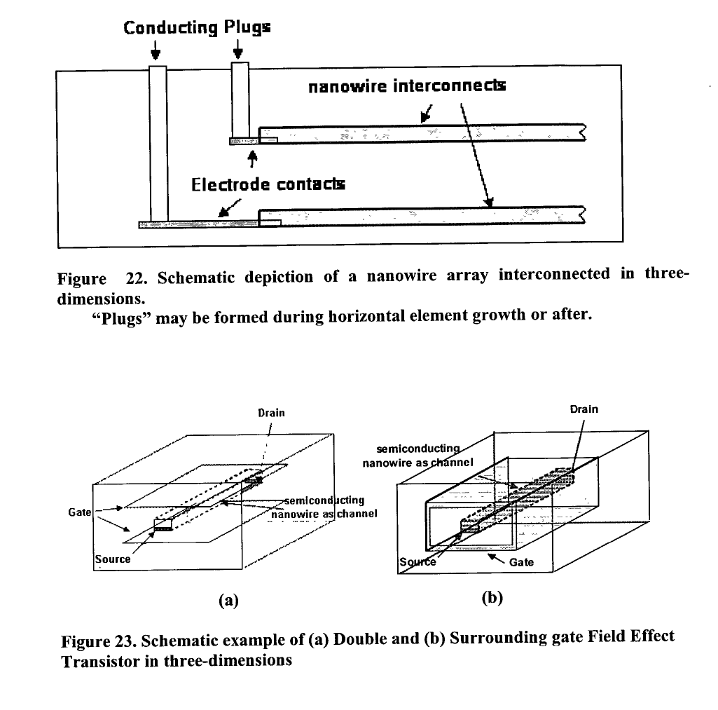

The nano devices built up by filaments used in situ in their templates can be stacked layer by layer to increase the magnetic filament array or electric or sensor device array densities and decrease delays due to the shorter interconnects such as suggested by FIG. 22. In this particular example of a 3-D architecture, vertical vias are fabricated by lithography and sequential etching of the via hole, these vias may also be fabricated by selective deposition, lift-off techniques or directed growth. The via hole can be filled by the same growth being used to create the horizontal element or, the etching creating the via can be done after horizontal growth and then followed, for example, by growth in the via or by selective metal chemical vapor deposition in the via. Of course, vertical connections are only used as necessary and when advantageous. In some cases such vias may not be necessary since filaments formed in other templates radiating out from the regions labeled “electrode contacts” will be the interconnecting circuitry.

Arrays of three dimensional double and surrounding gate FETs are now possible with this in situ use of filaments left in their forming templates. Such exemplary three-dimension structures are shown in FIGS. 23(a) and 23(b), respectively. The double gates can be accomplished by depositing another insulating layer and sequential gate electrode above the device whose first gate is underneath the nanowire as shown in FIG. 21. The surrounding gate of FIG. 23b is obtained by further connecting the two gates in FIG. 23(a) by using etching followed by metal deposition and definition. The multiple gates help the on-off device current controllability.

As discussed above, the chemical reactor templates of the invention provide a general approach to fully designable and controllable templates for use in ex situ and in situ applications. The chemical reactor templates may be used for any type of chemical reaction in which the reactants may introduced into the template's channels either during fabrication of the template or through a channel of the template. In a preferred embodiment, the chemical reactor templates are used to produce filaments by polymerizing monomers within a template channel producing highly oriented filaments. Any type of polymerization reaction may be used to produce the highly oriented filaments. For example, free radical polymerization of vinyl monomers (e.g. methylmethacrylate or acrylonitrile with an initiator such as AIBN), catalyzed polymerizations such as norbornene to polynorborene in the presence of [Pd(CH₂CN)₄][BF₄} or ethylene to polyethylene in the presence of TiCl₄.Al(C₂H₅)₃ or photo-initiated polymerizations such as polymerizing 1,4 Diiodothiophene. Using a chemical reactor template of the invention polymer filaments composed of a single polymer macromolecule of any length may be formed. As discussed above, the polymers are highly oriented due to their formation within a chemical reactor template of the invention.

Sensors and Diagnostics

The template structures of the invention can also be used for sensing applications and for diagnostics. Typical pores or holes in biological membranes are formed by proteins or peptides and have interior diameters on the nanometer size scale (1-100 nm). These nanoscale structures may be used as an artificial pore structures such as an ion pore which controls and measures the ion current traveling through the nanoscale channel. See “Characterization of nucleic acids by nanopore analysis”, Deamer D W, Branton D, ACCOUNTS OF CHEMICAL RESEARCH 10, 817-825 (2002). Pores have many functions of biological relevance, such as nuclear pores allowing the transit of RNA, ion pores which selectively allow the passage of unique ions, cell wall pores, such as connexins, which allow adjoining cells to communicate with one another and many other functions. One application for a nanometer scale artificial pore is the sequencing of nucleic acids or proteins. By measuring the current of single or small numbers of ions transiting the pore it is possible to determine the composition of the material as it transits. If electrodes are included inside the pore, which is possible using these nanoscale template fabrication techniques, then electrochemical reactions can be driven which will allow even more detailed compositional data by examining the reduction and oxidation of molecules or their components. One possible electrochemical reaction is the oxidation or reduction of the bases of nucleic acids which occurs at very predictable voltages for the individual bases. These structures may also be used for delivering or withdrawing drugs, chemicals, analytes, hormones, enzymes proteins, peptides nucleic acids or other molecules to localized regions on eukaryotic cells, prokaryotic cells, bacteria, fungi, cell membranes, nuclear membranes, or other biological entities. Patch clamp recording of cellular function is possible by localizing cells against or near a nanoscale pore structure and measuring current through the pore into the cell.

The claimed invention is:

1. A chemical reactor template having at least two intersecting channel-like voids substantially parallel to the major axis of said template.

2. The chemical reactor template of claim 1, wherein the channel-like voids are micro-scale voids, nano-scale voids, or a combination thereof.

3. The chemical reactor template of claim 2, wherein at least two channel-like voids intersect to form a T-intersection, a Y-intersection, an X-intersection, or a +-intersection.

4. The chemical reactor template of claim 3, wherein the channel-like voids form a +-intersection wherein at least one channel-like void is a micro-scale void and at least one channel-like void is a nano-scale void.

5. The chemical reactor of claim 4, wherein the micro-scale channel-like void is opposite the nano-scale channel-like void.

6. The chemical reactor template of claim 5, wherein the micro-scale channel-like void contains a removable member which forms a check valve at the +-intersection.

7. The chemical reactor template of claim 6, wherein the removable member is a sphere, a rod, a pyramid, a triangle or a cone.

8. The chemical reactor template of claim 6, wherein the removable member comprises a catalyst material for a chemical reaction.

9. The chemical reactor template of claim 3, wherein the intersection defines a chemical reaction zone.

10. The chemical reactor template of claim 9, wherein a catalyst is present at the intersection.

11. A chemical reactor template having at least one nano-scale channel-like void substantially parallel to the major axis of said template.

12. The chemical reactor template of claim 11 having at least two nano-scale intersecting channel-like voids substantially parallel to the major axis of said template.

13. The chemical reactor template of claim 12, wherein at least two channel-like voids intersect to form a T-intersection, a Y-intersection, an X-intersection, or a +-intersection.

14. A chemical reactor template having at least one micro-scale channel-like void substantially parallel to the major axis of said template.

15. The chemical reactor template of claim 14 having at least two micro-scale intersecting channel-like voids substantially parallel to the major axis of said template.

16. The chemical reactor template of claim 15, wherein at least two channel-like voids intersect to form a T-intersection, a Y-intersection, an X-intersection, or a +-intersection.

17. The chemical reactor template of claim 1, 11, or 14 wherein at least one channel contains beads within at least a portion of one channel.

18. The chemical reactor template of claim 17, wherein the beads form a bead bed reactor within the channel.

19. A method for manufacturing a chemical reactor template comprising the steps of:
applying a sacrificial layer in a predetermined pattern on a substrate;
applying a capping layer such that the sacrificial layer is disposed between the capping layer and said substrate forming a chemical reactor template; and
removing said sacrificial layer to a create a channel-like void within the chemical reactor substrate, the channel-like void being substantially parallel to the substrate.

20. The method according to claim 19, wherein removing the sacrificial layer comprises etching, dissolving, gasifying, sublimating, or decomposing the sacrificial layer.

21. The method of claim 19, wherein the sacrificial layer comprises a void-rich material, a void-free material, a self-assembled molecule material, or beads.

22. The method of claim 21, wherein the sacrificial layer is a void-free material and the channel-like void has a nano-scale cross section.

23. The method of claim 19, further comprising, prior to applying the sacrificial layer, the step of applying a functional material to a region of the substrate, and wherein the sacrificial layer overlies at least a portion of the functional material.

24. The method of claim 19, further comprising, prior to applying the capping layer, the step of applying a functional material to a region of the substrate such that at least a portion of the functional material overlies the sacrificial material.

25. The method of claim 23 or 24, wherein the functional material is a catalyst, a catalyst precursor, or an electrical contact.

26. The method of claim 25, wherein the functional material is a catalyst precursor, further comprising, after removing the sacrificial layer, the step of converting the catalyst precursor to an active catalyst.

27. A method for manufacturing a chemical reactor template comprising the steps of:
a. applying a first sacrificial layer in a predetermined pattern on a substrate;
b. applying a first capping layer such that the first sacrificial layer is disposed between the capping layer and said substrate;
c. applying a subsequent sacrificial layer in a predetermined pattern on the previously applied capping layer;
d. applying a subsequent capping layer such that the subsequent sacrificial layer is disposed between the subsequent capping layer and the previously applied capping layer;
e. optionally repeating steps (c) and (d).
f. removing the first and subsequent sacrificial layers to create channel-like voids within the chemical reactor template, the channel-like voids being substantially parallel to the substrate.

28. The method of claim 27, wherein the first sacrificial layer is removed prior to applying the subsequent sacrificial layer.

29. The method of claim 27, wherein the first and subsequent sacrificial layers are removed in separate steps.

30. The method of claim 27, wherein the predetermined pattern used to apply the subsequent sacrificial layer is substantially the same as the predetermined pattern used to applying the first sacrificial layer.

31. The method of claim 27, further comprising the step of creating at least one via to vertically connect the channel-like voids.

32. The method of claim 31, wherein said via comprises an access hole or an interconnect.

33. A method for producing a filament using a chemical reactor template comprising the steps of:
introducing at least one monomer into a chemical reactor template having at least one channel-like void substantially parallel to the major axis of the template, and
polymerizing said monomer within the channel-like void to produce a filament within the channel-like void.

34. The method of claim 33, wherein the monomer is acetylene.

35. The method of claim 33, wherein the polymerization step is an electrochemical-assisted polymerization.

36. The method of claim 33, wherein the channel-like voids are micro-scale voids, nano-scale voids, or a combination thereof.

37. A method for producing a semiconductor, dielectric, metal or semi-metal filament using a chemical reactor template comprising the steps of:
introducing at least one precursor of a semiconductor, dielectric, metal or semi-metal into a chemical reactor template having at least one channel-like void substantially parallel to the major axis of the template, and
reacting the precursor within the channel-like void to produce a semiconductor, dielectric, metal or semi-metal filament within the channel-like void.

38. The method of claim 37, wherein the precursor is acetylene monomer.

39. The method of claim 37, wherein the reaction step comprises polymerizing the precursor.

40. The method of claim 39, wherein the reaction step is an electrochemical-assisted polymerization.

41. The method of claim 37, wherein the channel-like voids are micro-scale voids, nano-scale voids, or a combination thereof.

42. A method for producing a filament using a chemical reactor template comprising the steps of:
introducing at least one monomer into a chemical reactor template having at least one channel-like void substantially parallel to the major axis of the template, and
polymerizing said monomer within the channel-like void to extrude a filament from the channel-like void.

43. The method of claim 42, wherein the channel-like voids are micro-scale voids, nano-scale voids, or a combination thereof.

44. A method for producing a filament using a chemical reactor template comprising the steps of:
introducing at least one monomer into a chemical reactor template having at least one channel-like void substantially parallel to the major axis of the template,
polymerizing said monomer within the channel-like void to produce a filament within the channel-like void, and
extruding the filament from the chemical reactor template.

45. The method of claim 44, where the filament is extruded using an electric field, a chemical reaction or an electrochemical reaction.

46. A method for producing a filament using a chemical reactor template comprising the steps of:
introducing at least one monomer into a chemical reactor template having at least one channel-like void substantially parallel to the major axis of the template,
polymerizing said monomer within the channel-like void to produce a filament within the channel-like void, and
removing a portion of the chemical reactor template to expose at least a portion of the filament within the channel-like void.

47. The method of claim 46, wherein the monomer is acetylene.

48. The method of claim 46, wherein the channel-like voids are micro-scale voids, nano-scale voids, or a combination thereof.

49. A method for producing at least one contact region between a first and second material system over a substrate comprising the steps of:
forming a first material system on a first region of the substrate;
forming a second material system on a second region of the substrate;
applying a sacrificial layer in a predetermined pattern on the substrate such that a portion of the sacrificial layer overlies at least a portion of the first material system and at least a portion of the second material system;
applying a capping layer such that the sacrificial layer is disposed between the capping layer and said substrate forming a chemical reactor template;
removing a sacrificial layer to a create a channel-like void within the chemical reactor template, the channel-like void being substantially parallel to the substrate;
introducing at least one monomer into said channel-like void; and
polymerizing said monomer within the channel-like void to produce a conductive or semi-conductive filament within the channel-like void, wherein said filament is in contact with the first and second material systems.

50. The method of claim 49, wherein the monomer is acetylene and the filament is polyacetylene.

51. The method of claim 49, further comprising, during or after the polymerizing step, the step of doping the conductive or semi-conductive filament.

52. The method of claim 49, wherein the production of at least one contact region between a first and a second material system provides for fabrication of a structure selected from the group consisting of a MEMS device, cantilever structure, micro-switch structure, micro-mirror structure, actuator, field-emission structure, bolometric structure, accelerometer, biomedical or medical device, sorting and affixing structure, and an electrical, chemical or electrochemical sensor.

53. A method for producing a particle using a chemical reactor template comprising the steps of:
introducing at least one monomer into a chemical reactor template having at least one channel-like void substantially parallel to the major axis of the template, and
polymerizing said monomer within the channel-like void to form a particle within the channel-like void.

54. The method of claim 53, wherein the channel-like voids are micro-scale voids, nano-scale voids, or a combination thereof.

55. An oriented polymer filament having a nano-scale cross-sectional area prepared by polymerizing a monomer or comonomer within a channel having a nano-scale cross-section.

56. The oriented polymer filament of claim 55, wherein the polymerizing step comprises free radical polymerization, condensation polymerization, photo-initiated polymerization, or electrochemical-assisted polymerization.

57. The oriented polymer filament of claim 55, wherein the polymer is polyacetylene prepared by polymerizing acetylene monomers.

58. An oriented polymer filament having a micro-scale cross-sectional area prepared by polymerizing a monomer or comonomer within a channel having a nano-scale cross-section.

59. The oriented polymer filament of claim 58, wherein the polymerizing step comprises free radical polymerization, condensation polymerization, photo-initiated polymerization, or electrochemical assisted polymerization.

60. The oriented polymer filament of claim 58, wherein the polymer is polyacetylene prepared by polymerizing acetylene monomers.

61. An oriented filament having a nano-scale cross-sectional area prepared by polymerizing a monomer or comonomers with a channel having a nano-scale cross-section to form a polymer and decomposing the polymer within the channel to form a filament.

62. The oriented filament of claim 61, wherein the filament is a carbon nanotube.

63. A method for producing a filament using a chemical reactor template comprising the steps of:
introducing at least one monomer into a chemical reactor template having at least two channel-like voids substantially parallel to the major axis of the template, and
polymerizing said monomer within the channel-like voids to extrude a filament from the channel-like void to form a weave.

64. A method for producing a filament using a chemical reactor template comprising the steps of:
introducing at least one monomer into a chemical reactor template having at least two channel-like voids substantially parallel to the major axis of the template,
polymerizing said monomer within the channel-like voids to produce a filament within the channel-like void, and
extruding the filament from the chemical reactor template to form a weave.

65. A devise selected from the group consisting of a MEMS device, cantilever structure, micro-switch structure, micro-mirror structure, actuator, field-emission structure, bolometric structure, accelerometer, biomedical or medical device, sorting and affixing structure, and an electrical, chemical or electrochemical sensor prepared according to claim 49.
